(19) United States
(12) Patent Application Publication
(10) Pub. No.: US 2008/0228815 A1
(43) Pub. Date: Sep. 18, 2008

(54) METHODS AND SYSTEMS FOR MANAGING RISK

(76) Inventors: Kevin J. Senn, Diablo, CA (US); Nathan L. Scheg, Concord, CA (US)

Correspondence Address: PATRICK W. RASCHE;ARMSTRONG TEASDALE LLP, ONE METROPOLITAN SQUARE, SUITE 2600, ST. LOUIS, MO, 63102-2740, US

(21) Appl. No.: 11/686,476

(22) Filed: Mar. 15, 2007

(51) Int. Cl. G06F 17/30

(52) U.S. Cl. 707/104.1; 707/E17.005

(57) ABSTRACT

A method for managing risk associated with a construction project by a business entity using a computer system coupled to a database is provided. The method includes storing within the database information relating to at least one construction project including tasks to be performed and deadlines associated with each task, wherein the information stored within the database further includes a plurality of documents associated with the at least one construction project. The method also includes analyzing a content of each document stored within the database, and determining whether to trigger an alert based on the content of each document. The method also includes displaying on the computer system each alert relating to the construction project, prompting a user to associate with the business entity to take steps to correct each alert displayed on the computer system to facilitate timely completion of the construction project, and updating the alerts displayed on the computer system to include the corrective steps taken by the user.

### BACKGROUND OF THE INVENTION

This invention relates generally to managing risk and, more particularly, to methods and systems for managing risk associated with providing services and products.

Generally, risk is a measure of the potential loss versus gain for any given act or omission related to a project or business operation. For a given risk, there are levels, or values, which quantify the risk and can be used to determine if the risk is too great to be acceptable. If the risk associated with a particular project or business can be managed effectively, the project or business should remain a viable, ongoing concern.

For example, with respect to a real estate development project, a developer typically coordinates and manages many different types of relationships, including with contractors, subcontractors, inspectors, architects, engineers, consultants and governmental entities. On any given significant project, there may twenty or more different contractors and subcontractors performing work on the project. For each contractor and subcontractor, there typically is at least one or more main agreement, and over the course of the project, there may be many different modifications, additions, and subtractions to the contracts. There also are likely numerous architect drawings, engineering reviews, inspections, reports, licenses, and other documentation. While the developer is focused on timely and proper completion of the project, there may not be much focus on ensuring the completeness and accuracy of all the documentation created, or that should be created, over the course of the project. Simply locating a particular document may be challenging. In the event of a dispute relating to such project, the developer may face significant challenges in identifying and locating documentation relevant to the particular matter which is the subject of the dispute. For multiple projects across an enterprise, such risk management becomes even more challenging.

The challenges described above in connection with real estate development projects arise in many other contexts as well. For example, in connection with bringing a new drug to the market, a pharmaceutical company is faced with many of the same challenges, if not more, as a real estate developer. Similar challenges are encountered when brining a new product to market.

### BRIEF DESCRIPTION OF THE INVENTION

In one aspect, a method for managing risk associated with a construction project by a business entity using a computer system coupled to a database is provided. The method includes storing within the database information relating to at least one construction project including tasks to be performed and deadlines associated with each task, where the information stored within the database further includes a plurality of documents associated with the at least one construction project. The method also includes analyzing a content of each document stored within the database, determining whether to trigger an alert based on the content of each document herein an alert represents a failure to perform at least one of the tasks of the construction project before the scheduled deadline. Moreover, the method includes displaying on the computer system each alert relating to the construction project, prompting a user to associate with the business entity to take steps to correct each alert displayed on the computer system to facilitate timely completion of the construction project, and updating the alerts displayed on the computer system to include the corrective steps taken by the user.

In another aspect, a computer system for a company engaged in the business of managing risk is provided. The computer system includes at least one computer configured as a server, the server associated with the risk management company and containing a database. The server is configured to store within the database information relating to at least one construction project including tasks to be performed and deadlines associated with each task, wherein information stored within the database further includes a plurality of documents associated with the at least one construction project. The server is also configured to analyze a content of each document stored within the database, determine whether to trigger an alert based on the content of each document wherein an alert represents a failure to perform at least one of the tasks of the construction project before the scheduled deadline, display on the computer system each alert relating to the construction project, prompt a user associated with the business entity to take steps to correct each alert displayed on the computer system to facilitate timely completion of the construction project, and update the alerts displayed on the computer system to include corrective steps taken by the user.

In yet another aspect, an apparatus is provided that includes means, associated with a risk management company, for storing information relating to at least one construction project including tasks to be performed and deadlines associated with each task, wherein the information includes a plurality of documents associated with the at least one construction project. The apparatus also includes means for analyzing a content of each document, means for determining whether to trigger an alert based on the content of each document wherein an alert represents a failure to perform at least one of the tasks of the construction project before the scheduled deadline, means for displaying each alert relating to the construction project, means for prompting a user associated with the business entity to take steps to correct each displayed to facilitate timely completion of the construction project, and means for updating the displayed alerts to include the corrective steps taken by the user.

### BRIEF DESCRIPTION OF THE DRAWINGS

FIG. 1 is a simplified block diagram of a Risk Management System (RMS) in accordance with one embodiment of the present invention.

FIG. 2 is an expanded version block diagram of an example embodiment of a server architecture of the RMS.

FIG. 3 is a flowchart illustrating exemplary processes utilized in the RMS.

FIG. 4 is a more detailed flowchart illustrating exemplary processes utilized in RMS.

FIG. 5 is a more detailed flowchart illustrating exemplary processes utilized in RMS.

FIG. 6 is an example embodiment of a user interface displaying a Home page of the RMS system.

FIG. 7 is an example embodiment of a user interface displaying a Login page of the RMS system.

FIG. 8 is an example embodiment of a user interface displaying an Administration Home page of the RMS system.

FIG. 9 is an example embodiment of a user interface displaying a Create New Account page of the RMS system.

FIG. 10 is an example embodiment of a user interface displaying an Account List page of the RMS system.

FIG. 11 is an example embodiment of a user interface displaying a User Summary page of the RMS system.

FIG. 12 is an example embodiment of a user interface displaying an Edit Account Dialog page of the RMS system.

FIG. 13 is an example embodiment of a user interface displaying a User List page of the RMS system.

FIG. 14 is an example embodiment of a user interface displaying a Manage User Group page of the RMS system.

FIG. 15 is an example embodiment of a user interface displaying a Compose Window page of the RMS system.

FIG. 16 is an example embodiment of a user interface displaying an Account Summary page of the RMS system.

FIG. 17 is an example embodiment of a user interface displaying a Property Overview page of the RMS system.

FIG. 18 is an example embodiment of a user interface displaying a Create New Alert page of the RMS system.

FIG. 19 is an example embodiment of a user interface displaying a Select User Type page of the RMS system.

FIG. 20 is an example embodiment of a user interface displaying a Create New User page of the RMS system.

FIG. 21 is an example embodiment of a user interface displaying a Create New User page for a Global User of the RMS system.

FIG. 22 is an example embodiment of a user interface displaying an Alert Summary page of the RMS system.

FIG. 23 is an example embodiment of a user interface displaying a Property List page of the RMS system.

FIG. 24 is an example embodiment of a user interface displaying an Applications Settings page of the RMS system.

FIG. 25 is an example embodiment of a user interface displaying an Account Summary page of the RMS system.

FIG. 26 is an example embodiment of a user interface displaying a Property Administration Overview page of the RMS system.

FIG. 27 is an example embodiment of a user interface displaying a Property Alert Summary page of the RMS system.

FIG. 28 is an example embodiment of a user interface displaying an Archived Alert Summary page of the RMS system.

FIG. 29 is an example embodiment of a user interface displaying a Property Alert Notification page of the RMS system.

FIG. 30 is an example embodiment of a user interface displaying an Alert Approval Request page of the RMS system.

FIG. 31 is another example embodiment of a user interface displaying an Edit Approval Path page of the RMS system.

FIG. 32 is another example embodiment of a user interface displaying a Delete Alert page of the RMS system.

FIG. 33 is also another example embodiment of a user interface displaying an Alert Details page of the RMS system.

FIG. 34 is also another example embodiment of a user interface displaying a New Property Contact page of the RMS system.

FIG. 35 is an example embodiment of a user interface displaying a Create New Property Profile page of the RMS system.

FIG. 36 is an example embodiment of a user interface displaying a New Account Image page of the RMS system.

FIG. 37 is an example embodiment of a user interface displaying a New Property Image page of the RMS system.

FIG. 38 is an example embodiment of a user interface displaying a Select User Account page of the RMS system.

FIG. 39 is an example embodiment of a user interface displaying a Select User Type page of the RMS system.

FIG. 40 is an example embodiment of a user interface displaying a Global User page of the RMS system.

FIG. 41 is an example embodiment of a user interface displaying a User Permissions page of the RMS system.

FIG. 42 is an example embodiment of a user interface displaying a Property Security page of the RMS system.

FIG. 43 is an example embodiment of a user interface displaying a Document Upload page of the RMS system.

FIG. 44 is an example embodiment of a user interface displaying a Project Library page of the RMS system.

FIG. 45 is an example embodiment of a user interface displaying a Collaboration Library page of the RMS system.

FIG. 46 is an example embodiment of a user interface displaying a Document Integration page of the RMS system.

FIG. 47 is another example embodiment of a user interface displaying a Document Integration page of the RMS system.

FIG. 48 is yet another example embodiment of a user interface displaying a Document Integration page of the RMS system.

FIG. 49 is an example embodiment of a user interface displaying a Pre-Construction Documents page of the RMS system.

FIG. 50 is an example embodiment of a user interface displaying a Course-of-Construction Documents page of the RMS system.

FIG. 51 is another example embodiment of a user interface displaying a Post-Construction Documents page of the RMS system.

FIG. 52 is an example embodiment of a user interface displaying a Document Repository—Advanced Search page of the RMS system.

FIG. 53 is another example embodiment of a user interface displaying a Document Repository—Advanced Search page of the RMS system.

FIG. 54 is yet another example embodiment of a user interface displaying a Document Repository—Advanced Search page of the RMS system.

FIG. 55 is another example embodiment of a user interface displaying a Documents Repository—My Favorites page of the RMS system.

FIG. 56 is another example embodiment of a user interface displaying a Document Repository—Browse All page of the RMS system.

FIG. 57 is another example embodiment of a user interface displaying a Document Repository—Search Results page of the RMS system.

### DETAILED DESCRIPTION OF THE INVENTION

The methods and systems described herein facilitate management of risk, e.g., litigation risk. The methods and systems described herein are believed to be applicable to many different industries for managing many different types of risks. The example embodiment described herein is the construction industry. Although the construction industry is the example industry described herein, the invention is in no way limited to the construction industry.

Exemplary embodiments of systems and processes that facilitate integrated network-based electronic reporting and workflow process management related to a Risk Management System (RMS) for the construction industry are described below in detail. The systems and processes facilitate, for example, electronic submission of information using a client system, automated extraction of information, and web-based reporting for internal and external system users. A technical effect of the systems and processes described herein include at least one of permitting a business entity to manage, budget, track and report contractor progress, timeliness, documentation and construction expenditures. More specifically, in the example embodiment, a business entity that is engaged in the business of developing real property, including but not limited to, building commercial and residential projects, utilizes RMS to manage, budget, track and report construction issues to decrease an overall risk factor incurred by the business entity as part of developing real property, and retain supporting documentation. For example, a claim may be filed due to a construction delay or defect. A delay may be due to public sector project involvement whereas construction defects generally are due to private sector involvement.

It should be understood that the RMS system is designed to identify, monitor and resolve any requirement and related risks that may arise during the course of a construction project, from inception to completion of the project. For example, the RMS system may identify and timely resolve issues, such as, but not limited to, project delays, project design, altered documents, missing documents, insurance issues and potential construction defects.

In the exemplary embodiment, the RMS system is utilized to collect, track, display, and disseminate construction documents and records regarding items such as, but not limited to, contractor progress, timeliness and construction expenditures for a business entity. The systems and processes described herein generally include the following construction phases: Pre-Construction, Course-of-Construction, and Post-Construction. At least some of the parties that may be involved in these systems and processes include contractors and internal project managers. The term “contractor” refers to outside construction companies that build construction projects for the business entity and that get paid, under the terms of a contract, by the business entity. Contractors include the general contractor and the subcontractors. Internal project manager refers to the internal construction specialists within the business entity who coordinate project construction with the contractors and approve payment for completed work.

The exemplary embodiment of the RMS system provides member authentication and account management features. Users become members upon logging into the RMS system and are given read only access to information pertaining to only their properties. Management features are incorporated into the RMS system using an Administration Home page accessible only to members granted administrator permissions. Administrators are typically associated with the business entity controlling the RMS system and have all permissions given to members in addition to the administrative features for accounts, properties and alerts. There are places within the RMS system where context menus appear if the member has Administrator permissions.

In the example embodiment, the Administrator is able to perform many system tasks, such as but not limited to: creating new accounts; viewing the list of accounts; editing existing accounts; increasing the number of members permitted to access data of a particular property; creating alerts; editing alerts and archiving alerts.

The example embodiment provides property managers with web based property management and alerting services. Members are able to login to the RMS and are able to access filtered views of property data based on the particular permissions assigned to each particular member. Limited alerting features are also provided that inform members of various issues for a selected property.

Alerts are based on project documentation and current status of project construction. The Administrator determines when a document or construction related event takes place or not. When these events do not occur as scheduled, to keep the project running smoothly, the Administrator posts alerts so that these outstanding documentation and construction issues can be resolved in a timely fashion. Administrators or members with Administration permissions enter the alerts into the RMS system. The alerts are linked to project documents. Each alert indicates a time required for response. Different alert levels may have different response times and response time criteria. For example, a red alert may require a minimum response time whereas yellow alerts may allow considerably more response time. Green alerts indicate closed-out items, or the resolution of a yellow or red alert.

Additionally, the users with proper Administration permissions are able to interact with the alert items to change its status and/or comment on actions taken. Further, the RMS system may include data storage capabilities or may alternatively interact with a third party data storage vendor. The RMS system allows members to login and seamlessly query the third party data storage system for property information without additional member authentications. Property information is then returned to the end member. The RMS system has an inherent security model managed through an administration home page along with all other administration features. The RMS system may be used to store the documents associated with any business or field of endeavor, as well as contemporaneously interacting with members and Administrators before, during and after a project.

For example, the business entity may procure the services of architects and engineers to design commercial or residential improvements to a parcel of real property. Given that the business entity desires to build the designed improvements, the business entity obtains construction professionals to manage the construction and procures contracting companies to build the proposed improvements.

Prior to commencing construction, also known as the Pre-Construction phase, tasks such as but not limited to, negotiating contracts between the general contractor and the various sub-contractors must be completed, design drawings must be approved, permits must be obtained, and utilities must be located. Furthermore, during the Pre-Construction phase of the project the developer obtains pre-underwriting certification, all of the construction defect risk management resources are designed, and the developer, general contractor, and subcontractors receive training using the RMS system. They are taken through a rigorous certification process that positions them to obtain favorable insurance treatment, deliver a high quality product, preempt the threat of litigation, and ultimately increase their profits. Moreover, ‘Peer Review’ of critical construction documents that track and assign responsibility among and between general contractors, subcontractors, design and product suppliers is implemented. ‘Peer Review’ includes, but is not limited to, having engineers checking each others' work for errors, thus minimizing design changes and project delays, identifying erroneous calculations and related safety issues, and minimizing additional costs associated therewith. All of the documents associated with these and the many other tasks performed as part of the Pre-Construction phase are electronically stored and integrated into the project database.

During the Course-of-Construction phase, a plurality of documents are generated, such as, but not limited to, design modifications resulting in change orders, shop drawings, RFI's (Request for Information), contracts, weather documentation, quantities of materials required for construction, results of inspections and reports created by third party consultants. In the exemplary embodiment, all construction documents are collected weekly from all parties involved in the project, including, but not limited to, the developer, general contractor and the subcontractors. The documents are reviewed for items such as dates, quantities, proper signatures, delay, design changes, proper execution, insurance and potential construction defects. After addressing outstanding issues identified during the review, the documents are electronically stored. Additionally, monthly on site audits and closed/open item tracking is performed and monthly reports are issued. Moreover, in addition to electronically recording the documents, all critical construction documents themselves are also preserved.

Post-Construction activities generate documents such as as-built drawings, warranties, purchase and sale agreements and marketing documentation that are also stored in the RMS system. Additionally, during this final stage of the construction project, the documents are certified and risk aptitude benchmarking for future trade partner selections is performed, yielding a set of audited documents. The electronic version of all documents, data, photos and videos created during the project is maintained for a predetermined period of time.

It should be appreciated that although the example discussed above is from the construction industry, the RMS system may be used in any other business or field of endeavor involving records and documentation. For example, the RMS system can also be used in the pharmaceutical industry including the phases of initial product research, product development and sales to market. However, it should further be appreciated that other businesses or organizations may not have clearly discernable phases of project development and that for each business or organization phasing will be unique.

In the exemplary embodiment, construction documents may be received and entered into RMS either manually or electronically. Once the documents have been digitally stored in the RMS system, they can be easily accessed through any computer monitor or similar device.

In one embodiment, a computer program is provided, and the program is embodied on a computer readable medium and utilizes a Structured Query Language (SQL) with a client user interface front-end for administration and a web interface for standard user input and reports. In an exemplary embodiment, the system is web enabled and is run on a business-entity intranet. In yet another embodiment, the system is fully accessed by individuals having an authorized access outside the firewall of the business-entity through the Internet. In a further exemplary embodiment, the system is being run in a Windows® NT environment (Windows is a registered trademark of Microsoft Corporation, Redmond, Wash.). The application is flexible and designed to run in various different environments without compromising any major functionality.

The systems and processes are not limited to the specific embodiments described herein. In addition, components of each system and each process can be practiced independently and separately from other components and processes described herein. Each component and process also can be used in combination with other assembly packages and processes.

In the exemplary embodiment, a quality, robust, multifunction interface and search engine, records and tracks documents generated and collected during Pre-Construction, Course-of-Construction and Post-Construction phases. The documents are reviewed and electronically stored in the RMS system as part of a data mapping of the project documentation. The RMS database and the data mapping of the documents stored therein provide a repository of readily accessible construction documents and information. Such a repository is helpful if future litigation or other disputes arise requiring any kind of construction project information or records.

The RMS system stores documents and makes those documents easily accessible such that the documents can be easily retrieved if litigation or other claim arises. The RMS system also provides the ability to obtain improved construction defect insurance terms, price, and conditions, namely, lower deductible, better coverage terms, fewer exclusions and lower premiums. Furthermore, the RMS system immediately provides accurate information to quickly and favorably resolve claims, should they arise. The RMS system enables business entities to enjoy a higher level of compliance regarding accountability regulations and avoid the negative publicity generated by problems with a public construction project. The RMS system enables all participants to have real-time control of the construction documentation process and instant access to project data allowing them to cost effectively manage the risk involved in construction projects. Moreover, the exemplary embodiment minimizes future litigation time and expense, and provides a means to consistently improve and refine construction best practices.

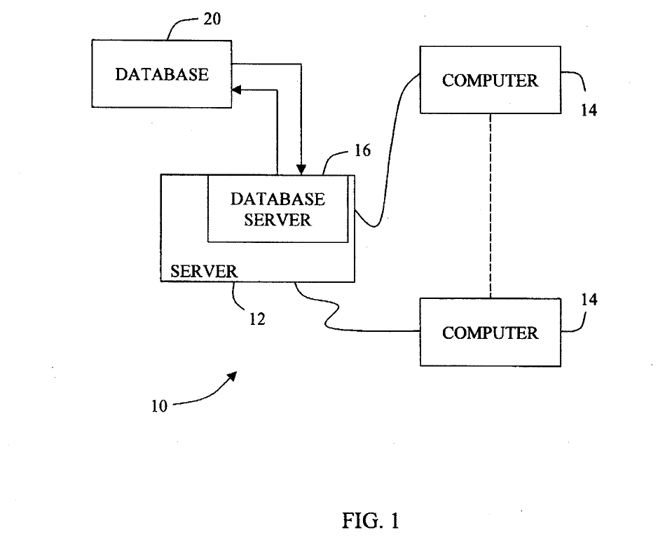

FIG. 1 is a simplified block diagram of a Risk Management System (RMS) 10 including a server system 12, and a plurality of client sub-systems, also referred to as client systems 14, connected to server system 12. Computerized modeling and grouping tools, as described below in more detail, are stored in server 12 and can be accessed by a requester at any one of computers 14. In one embodiment, client systems 14 are computers including a web browser, such that server system 12 is accessible to client systems 14 using the Internet. Client systems 14 are interconnected to the Internet through many interfaces including a network, such as a local area network (LAN) or a wide area network (WAN), dial-in-connections, cable modems and special high-speed ISDN lines. Client systems 14 could be any device capable of interconnecting to the Internet including a web-based phone, personal digital assistant (PDA), or other web-based connectable equipment. A database server 16 is connected to a database 20 containing information on a variety of matters, as described below in greater detail. In one embodiment, centralized database 20 is stored on server system 12 and can be accessed by potential users at one of client systems 14 by logging onto server system 12 through one of client systems 14. In an alternative embodiment, database 20 is stored remotely from server system 12 and may be non-centralized.

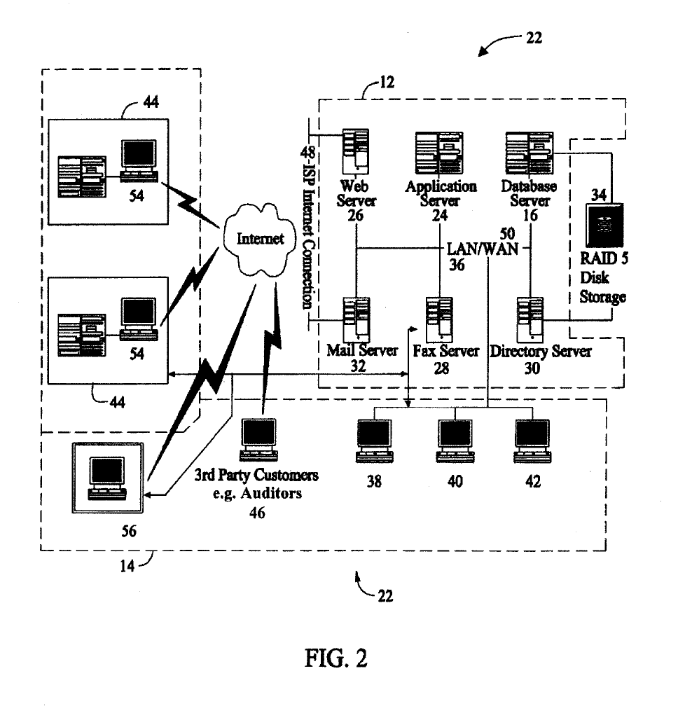

FIG. 2 is an expanded block diagram of an exemplary embodiment of a server architecture of a RMS 22. Components in system 22, identical to components of system 10 (shown in FIG. 1), are identified in FIG. 2 using the same reference numerals as used in FIG. 1. System 22 includes server system 12 and client systems 14. Server system 12 further includes database server 16, an application server 24, a web server 26, a fax server 28, a directory server 30, and a mail server 32. A disk storage unit 34 is coupled to database server 16 and directory server 30. Servers 16, 24, 26, 28, 30, and 32 are coupled in a local area network (LAN) 36. In addition, a system administrator's workstation 38, a user workstation 40, and a supervisor's workstation 42 are coupled to LAN 36. Alternatively, workstations 38, 40, and 42 are coupled to LAN 36 using an Internet link or are connected through an Intranet.

Each workstation, 38, 40, and 42 is a personal computer having a web browser. Although the functions performed at the workstations typically are illustrated as being performed at respective workstations 38, 40, and 42, such functions can be performed at one of many personal computers coupled to LAN 36. Workstations 38, 40, and 42 are illustrated as being associated with separate functions only to facilitate an understanding of the different types of functions that can be performed by individuals having access to LAN 36.

Server system 12 is configured to be communicatively coupled to various individuals, including employees 44 and to third parties, e.g., clients/customers, 46 using an ISP Internet connection 48. The communication in the exemplary embodiment is illustrated as being performed using the Internet, however, any other wide area network (WAN) type communication can be utilized in other embodiments, i.e., the systems and processes are not limited to being practiced using the Internet. In addition, and rather than WAN 50, local area network 36 could be used in place of WAN 50.

In the exemplary embodiment, any authorized individual having a workstation 54 can access RMS 22. At least one of the client systems includes a manager workstation 56 located at a remote location. Workstations 54 and 56 are personal computers having a web browser. Also, workstations 54 and 56 are configured to communicate with server system 12. Furthermore, fax server 28 communicates with remotely located client systems, including a client system 56 using a telephone link. Fax server 28 is configured to communicate with other client systems 38, 40, and 42 as well.

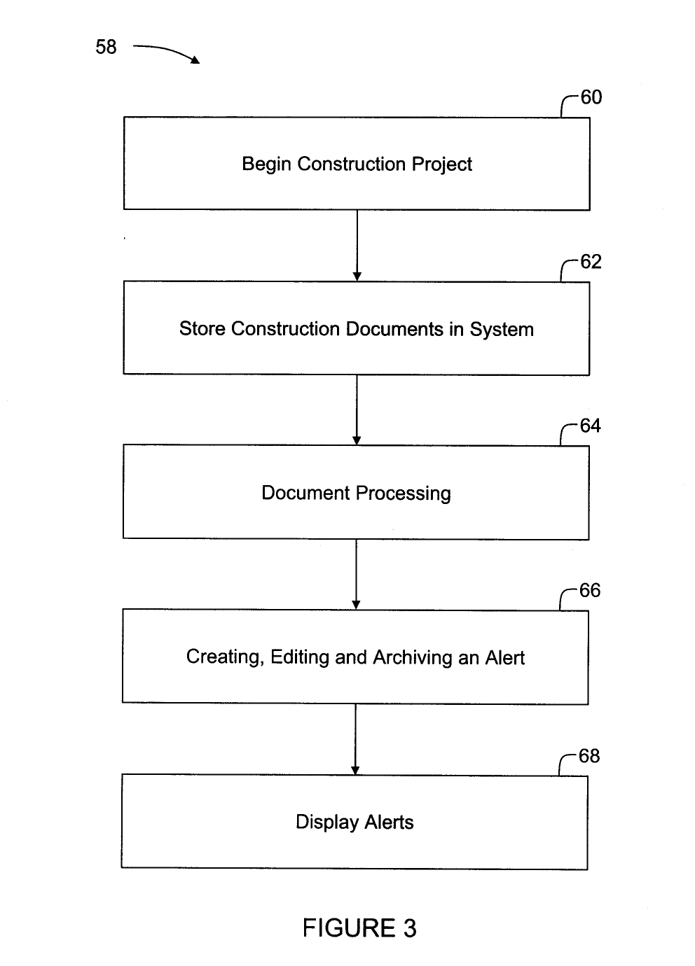

FIG. 3 is a flowchart illustrating exemplary processes used by the RMS system during a construction project. For the RMS system, construction projects begin 60 by establishing a new account in the RMS system before the Pre-Construction Phase of the project. Next, construction documents are collected and electronically stored 62 in the RMS system during the Pre-Construction, Course-of-Construction, and Post-Construction phases.

After storing the construction documents electronically, the documents are manipulated to become part of the system's searchable database. The collected documents are also processed 64 to evaluate whether an alert should be issued. Administrators are able to create, edit and archive 66 alerts. Once an alert has been created and approved, it is circulated to all approved members for display 68.

The technical effect of the processes and systems described herein is achieved when the business entity issues an alert based on construction related documents stored within the RMS system. For example, an alert may be issued when as-built drawings are not received, a change order is not signed, a purchase order is not returned or when a subcontractor agreement is not signed by the general contractor. The Administrator determines when a document or construction related event takes place or not. When these events do not occur as scheduled, to keep the project running smoothly, the Administrator posts alerts so that these outstanding documentation and construction issues can be resolved in a timely fashion. More specifically, the business entity creates a construction related document and subsequently stores an electronic version within RMS 10 (shown in FIG. 1) when the business entity engages engineers, architects, contractors and other necessary parties to design, build and otherwise complete a commercial or residential project. Specifically, the business entity creates a construction related document when anything relating to the project is recorded, be it the temperature on a given day or the contracts governing the relationships between the business entity and the contractors. The construction documents may be created by the business entity, contractors, governmental agencies, material suppliers, or any of the parties involved in the construction project.

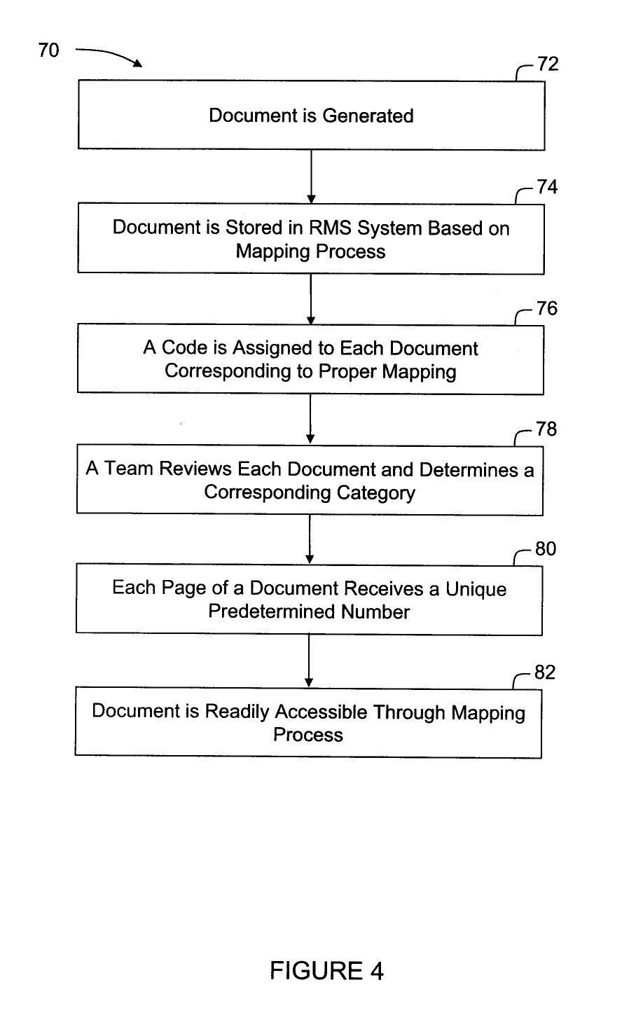

FIG. 4 is a more detailed flowchart 70 illustrating the exemplary processes of document processing 64 of FIG. 3 in greater detail, and for operation by users having administration permissions. Documents are generated 72 during the Pre-Construction, Course-of-Construction and Post-Construction phases of projects and may be generated in many formats, such as, but not limited to, paper and electronic. For example, documents such as, but not limited to letters, may be generated on paper, whereas drawings may be generated electronically as auto-cad or PDF files. In the exemplary embodiment, paper documents are converted into an electronic format by scanning. However, it should be appreciated that in other embodiments, documents may be converted into an electronic format by any appropriate means.

All paper documents are electronically stored 74 in the RMS system database. Each document is stored 74 in the database of the RMS system using a mapping process. More specifically, a code corresponding to the content of a document is assigned 76 to each document and stored within the system. In addition, the mapping process also includes storing for each document an address or location of where the document to stored within the database. The mapping process enables the system to organize the documents within the system for easy access and for displaying a link to the document on a user interface such that the user can more easily determine a document to be access. When a user desires to access a document, the user navigates to an appropriate web page within the RMS system and clicks on a corresponding document link displayed in an organized hierarchical system (e.g., specifically named folder) on the web page. The system then uses the mapping instructions stored in the database to locate the document stored in the RMS system database for easy retrieval. The RMS system uses and displays an organizational system for organizing the documents stored within the database based on the code assigned to each document. Thus, the RMS system is able to quickly retrieve and display documents.

The documents are categorized according to the phase of construction. That is, each document is identified as being generated during the Pre-Construction phase, the Course-of-Construction phase or the Post-Construction phase. The Pre-Construction phase of a construction project is defined as the time before receiving a notice-to-proceed from the owner of the project. Consequently, documents generated prior to the date of the notice-to-proceed are considered Pre-Construction phase documents. The Post-Construction phase of a construction project is defined as the time after receiving a notice of completion. Consequently, documents generated after the date of the notice of completion are considered Post-Construction phase documents. Documents generated between the date of the notice-to-proceed and the date of the notice of completion, are considered Course-of-Construction documents.

Each document is also categorized according to standard issues associated with construction projects, such as, but not limited to: business entity; changes or clarifications; closing documents; contracts; correspondence; digital or print media; entitlements; financials; insurance; maintenance; permits; plans; property purchases and sales; reports or inspections; and, warranties. Each category may also contain sub-categories. For example, the permits category may contain sub-categories, such as, but not limited to, city permits, state permits and all permits. It should be appreciated that although the exemplary embodiment is described as including the aforementioned categories, in other embodiments, the number of categorizes may be customized to include any number of categories corresponding any other construction related issue that enables the RMS system to function as described herein.

It should be understood that the RMS system defines the organizational structure to include a Pre-Construction document directory, a Course-of-Construction document directory and a Post-Construction document directory. Each directory is defined to include a plurality of folders that are each labeled or identified, according to category and sub-category, to reflect the contents of a corresponding document.

A team of document review professionals reviews each document 78 and determines which category and associated sub-category is most appropriate for each document. Each document is then electronically associated with the appropriate category and is readily accessible using the RMS.

After categorizing each document, each document is assigned a unique pre-determined document identification number 80, also known as a document control number (DCN). It should be understood that the document identification number includes the date a document is entered into the RMS system followed by a document number. For each day, the document number starts at one and increases sequentially to the total number of documents entered into the RMS system on a given day. For example, the first document entered into the RMS system on Jul. 4, 2007 may be given a DCN of 0704070001, and for Jul. 5, 2007 the tenth document may be given a DCN of 0705070010. It should be appreciated that the numbering format may be any format that enables the RMS system to function as described herein. Moreover, the date and time of each DCN assignment is recorded in the RMS system, and is associated with the assigned DCN. Furthermore, the RMS system is capable of referencing numbers directly stamped on documents themselves, such as, but not limited to, Bates stamps. Thus, the RMS system stores construction documents and provides ready access to those documents through a mapping process 82.

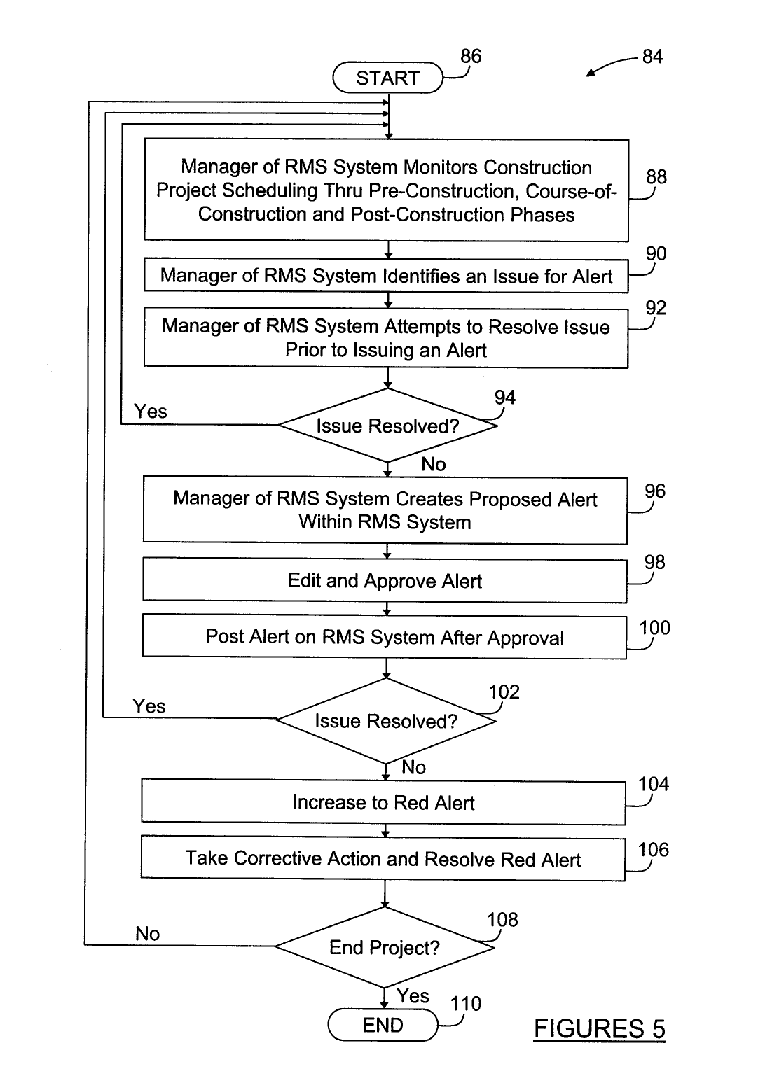

FIG. 5 is a flowchart 84 illustrating the exemplary processes of creating, editing and archiving an alert 66 of FIG. 3 in greater detail, and for operation by users having administration permissions. In the exemplary embodiment, each construction project starts 86 by establishing a project schedule including associated tasks to be completed. The schedule identifies deadlines for each task and is stored in the RMS system database. It should be appreciated that although the exemplary embodiment is described as including tasks and task deadlines, in other embodiments, the RMS system may identify, monitor and resolve any requirement and related risks that may arise during the course of a construction project, from inception to completion of the project. For example, the RMS system may identify and timely resolve issues, such as, but not limited to, project delays, project design, altered documents, missing documents, insurance issues and potential construction defects. As described above in relation to FIG. 4, construction documents relating to the project are also stored within the RMS system database.

During the duration of a construction project, a manager of the RMS system, also known as an auditor, uses the RMS system to continually analyze the content of each document stored within the database and monitors 88 the construction project schedule through the Pre-Construction, Course-of-Construction and Post-Construction phases of construction. Continually monitoring the status of the project schedule and related documents, facilitates identifying issues requiring an alert 90 and facilitates determining whether to trigger an alert based on the content of each document.

In the exemplary embodiment, an alert represents a failure to perform at least one of the tasks of the construction project before the scheduled deadline as detailed in the project schedule. It should be appreciated that although the exemplary embodiment is described as determining an alert based on documents and related schedule, in other embodiments, an alert represents a failure to close out via appropriate documentation at least one of the issues related to a construction project before project completion or another scheduled deadline. Such alerts may include, but not be limited to, delay, design, altered documents, incomplete documents, missing documents, insurance and potential defects.

Before generating an alert in the RMS system, the RMS system manager attempts to resolve the issue 92 without issuing an alert. If the RMS system manager is not able to satisfactorily resolve 94 the issue, the manager generates an alert within the RMS system 96. The alert is then available to Administrators having alert edit and approval authority. Each of the Administrators views the alert and is allowed to edit and approve the alert 98 before it is posted 100 to all of the RMS system users.

For example, if each subcontractor is to maintain minimum insurance coverage by making timely premium payments, documents stored within the RMS system may include the date of these payments for each subcontractor on the project. By monitoring the schedule, the manager notices that a premium payment date may be approaching and will generate an alert notifying a subcontractor that an insurance premium payment is due within a week. An Administrator having edit and approval authority may understand that the payment is for general commercial liability, not insurance, and edit the alert accordingly. Alternatively, an Administrator may change a status of the alert. After editing the alert, if all else is okay, the Administrator approves the alert. It should be appreciated that the number of users having edit and approval authority will vary on a job-by-job basis. After each of the Administrators have edited and approved the alert, the alert is posted on the RMS system and is accessible to all users. It should be understood that each alert establishes an electronic link between the alert and the corresponding document that triggered the alert.

Each alert is assigned a status using a hierarchy of alerts based on color. In the exemplary embodiment, the hierarchy of alerts includes four levels of alert: red; yellow; green; and black. Red alert status indicates an alert is open and requires attention and affirmative action is required by the client. Yellow alert status indicates an alert is in progress. That is, the alert has been reviewed by a client but the RMS managers are attempting to close it out, i.e. resolve it. Green alert status indicates an alert is closed. That is, the alert was reviewed, properly addressed, and proven closed by documentation. Black alert status indicates an alert has not been assigned red, yellow or green status. Most alerts are initially posted as yellow alerts. If an issue remains unresolved 102 then the alert status may be increased to red status 104 as the matter becomes more urgent. Generally, an alert is increased to red status after all options, that don't require client involvement, have been exhausted. An alert may also be given red status if it is urgent. When a matter obtains red alert status 104, the matter should be resolved immediately or else corrective action 106 will be taken. For example, if a subcontractor does not timely pay an insurance premium, he may not be permitted onto the construction site until payment is made and verified. It should be appreciated that although the exemplary embodiment describes corrective action as denying access to the construction site, in other embodiments, the corrective action may be any legal or other action designed to facilitate resolution of the alert and enable the RMS system to function as described herein.

The RMS system displays each alert relating to the construction project and prompts a user to associate, or contact, the owner, RMS system manager or other responsible party, to take steps to correct each alert displayed on the computer system. Thus, ensuring close out of potential issues that would have a potential negative impact on the construction project or facilitate timely completion of the construction project, and minimizing issues that would have a potential negative impact on the construction project. As alerts are resolved the RMS system updates the alerts displayed on the computer system to include the corrective steps taken by the user. For example, regarding the insurance premium discussed above, when the insurance premium is paid the RMS system includes this information in the alert and changes the status of the alert. When an issue is satisfactorily resolved, the alert status is changed to green and the alert is accessible through the RMS system for between about one to two weeks before being archived. When the project is completed 108, the RMS system manager ends 110 monitoring the project schedule and related documents.

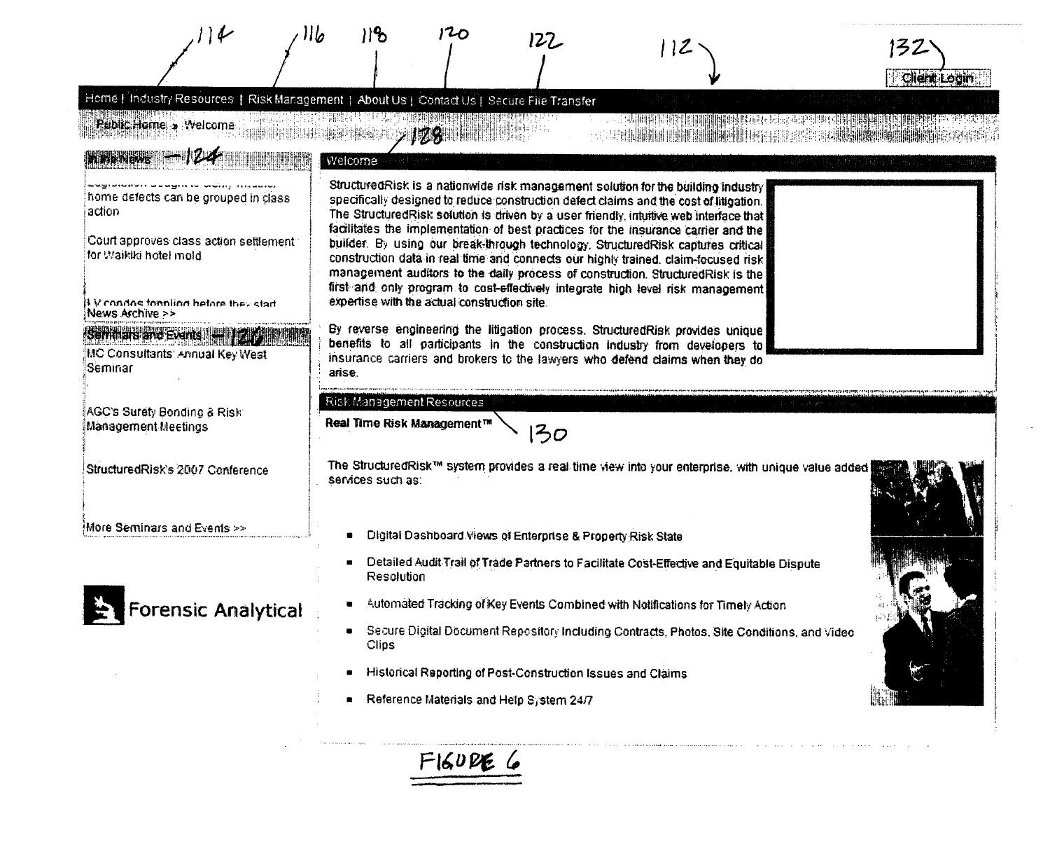

FIG. 6 is an example embodiment of a user interface 112 displaying a Home page of the RMS system. The Home page is shown when any user navigates the Internet to arrive at the address for this site. In the example embodiment, the Home page includes links to Industry Resources 114, Risk management 116, About Us 118, Contact Us 120 and Secure File Transfer 122 web pages of the RMS system. Further, an In the News Section 124, a Seminars and Events section 126, a Welcome Section 128, and a Risk Management Resources Section 130 are included in the Home page. There is also a Client Login button 132.

All users accessing the RMS system are initially un-authenticated and are considered anonymous until attempting to log into the RMS system. Anonymous users can access some features of the RMS system without logging into the system. Specifically, anonymous users can click all available links on the main Home page, such as the Contact Us link 120, the About Us link 118, the Risk Management link 116, the Industry Resources link 114 and the Secure File Transfer link 122. Anonymous users cannot access any other features of the system without logging on.

Anonymous users become members upon logging into the RMS system. Members are given limited permission to navigate through the RMS system for accessing information regarding only their properties, and cannot access information belonging to other members. Consequently, members of the website are provided filtered views of the various properties and associated alert data based on their permissions and corresponding properties. Members are not allowed to edit data, and instead have ‘read only’ access to their property information on the RMS system. Members may change their own passwords, but are required to contact the RMS system administrator if they have forgotten their password.

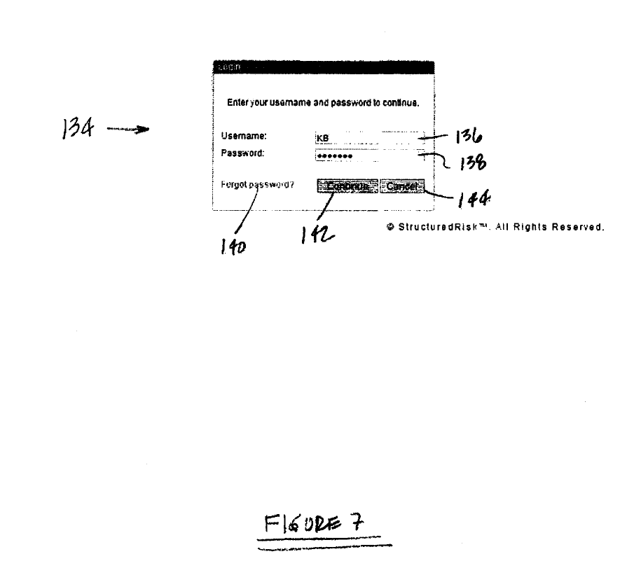

FIG. 7 is an example embodiment of a user interface 134 displaying a Login page for anonymous users desiring access to additional RMS data as members and administrators. The Login page comprises a Username data field 136 and a Password data field 138, a Forgot Password link 140, a continue button 142, and a cancel button 144.

In the example embodiment, a member or Administrator enters their assigned Username and Password in the corresponding fields, then clicks on the continue button 142 for entry into the RMS system. However, if a member or Administrator forgets their password, they should click on the “Forgot password” link 140 and will be taken to another web page within the RMS system to resolve the password issue. Additionally, if an anonymous user decides not to log into the system, clicking on the cancel button 144 leaves the Login page.

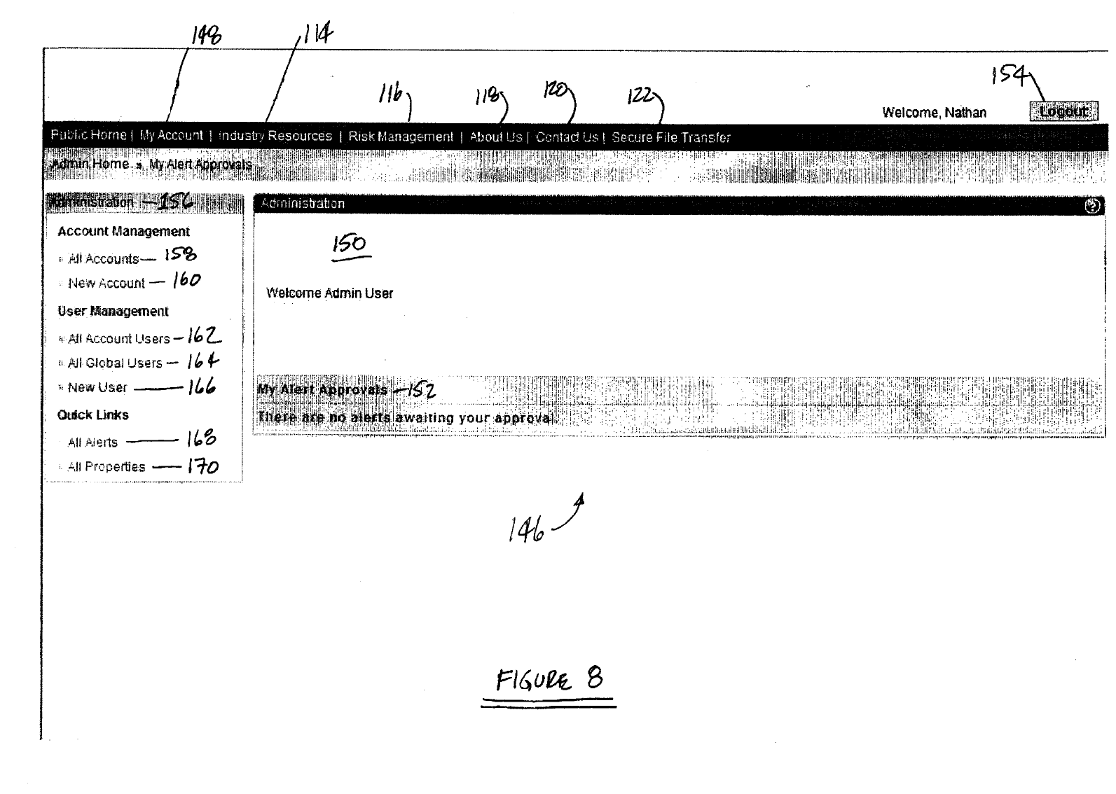

FIG. 8 is an example embodiment of a user interface 146 displaying an Administration Home page that is available only to members with Administration permissions. The Administration Home page contains the standard links to the About Us web page 118, Industry Resources web page 114, Risk Management web page 116, the Contact Us web page 120, the Secure File Transfer web page 122 and My Account page 148. Additionally, there is a Welcome Administrator User section 150 containing an Alert Approvals section 152 and a logout button 154.

The Administration Home page also includes one embodiment of an Administration Tool Bar 156 on the left containing links to several other pages within the RMS system. Those links include: All Accounts page link 158; New Account page link 160; All Account Users page link 162; All Global Users page link 164; New User page link 166; All Alerts page link 168; and an All Properties page link 170. In the example embodiment, the Administrator clicks on one of the several links to navigate to a desired page. Should the Administrator desire to exit the system while on the Administration Home page, he clicks logout button 154.

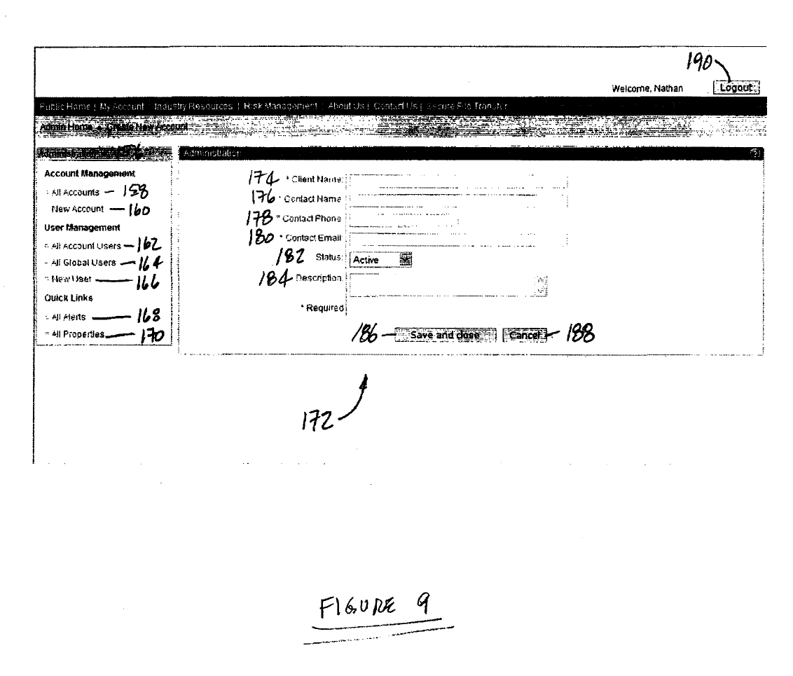

FIG. 9 is an example embodiment of user interface 172 displaying a Create New Account page. The Create New Account page includes the standard links at the top of the page and Administration Tool Bar 156 including links to other RMS system pages. The Create New Account page also includes data fields, such as: the Client Name 174, the Contact Name 176, the Contact Phone Number 178, the Contact E-mail 180, the Status pull-down 182, a Description 184, a Save and Close button 186 and a Cancel button 188. The Create New Account page also includes a logout button 190.

In the example embodiment, the Administrator enters the appropriate information in each of the data fields. Upon completely entering the data, the Administrator clicks the Save and Close button 186 to save the entered data, thus creating a new account. The Create New Account page can also be used to check the status of an account by selecting the Status Pull-Down menu 182. An Administrator may also decide not to enter data by clicking on the Cancel button 188. Upon clicking on the Save and Close button 186 or the Cancel button 188, the system returns to the Administrator Home page 146. The Administrator may also select any of the page links contained in the Administration Tool Bar 156 section to proceed directly to another page. Should the Administrator desire to exit the system while on the Create New Account page, he clicks the logout button 190.

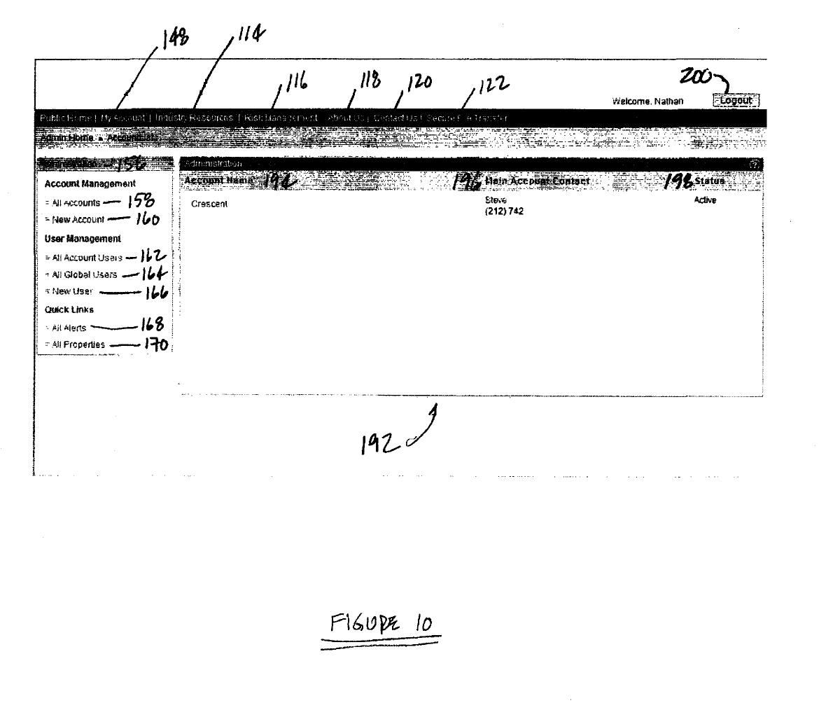

FIG. 10 is an example embodiment of a user interface 192 displaying an Account List page. The Account List provides information for each account, including: the Account Name 194; the Main Account Contact 196; and the Status 198 of the Account. FIG. 10 also contains Administration Tool Bar 156 with its associated page links and a logout button 200.

In the example embodiment, the Administrator clicks on the appropriate links of the Administration Home page 146 to navigate to the Account List page. The Administrator views the information displayed in the Account List page and may edit the information of each account in the Account List. The Administrator may click on the Main Account Contact Name 196 link which is a mailto:url for the Contact Name 196 e-mail address. Clicking the link opens a Compose Window page 264 populated with the Contact Names' 196 e-mail address. The Administrator may also select any of the page links contained in the Administration Tool Bar 156 section to proceed directly to another page. Should the Administrator desire to exit the system while on the Create New Account page, he clicks the logout button 200.

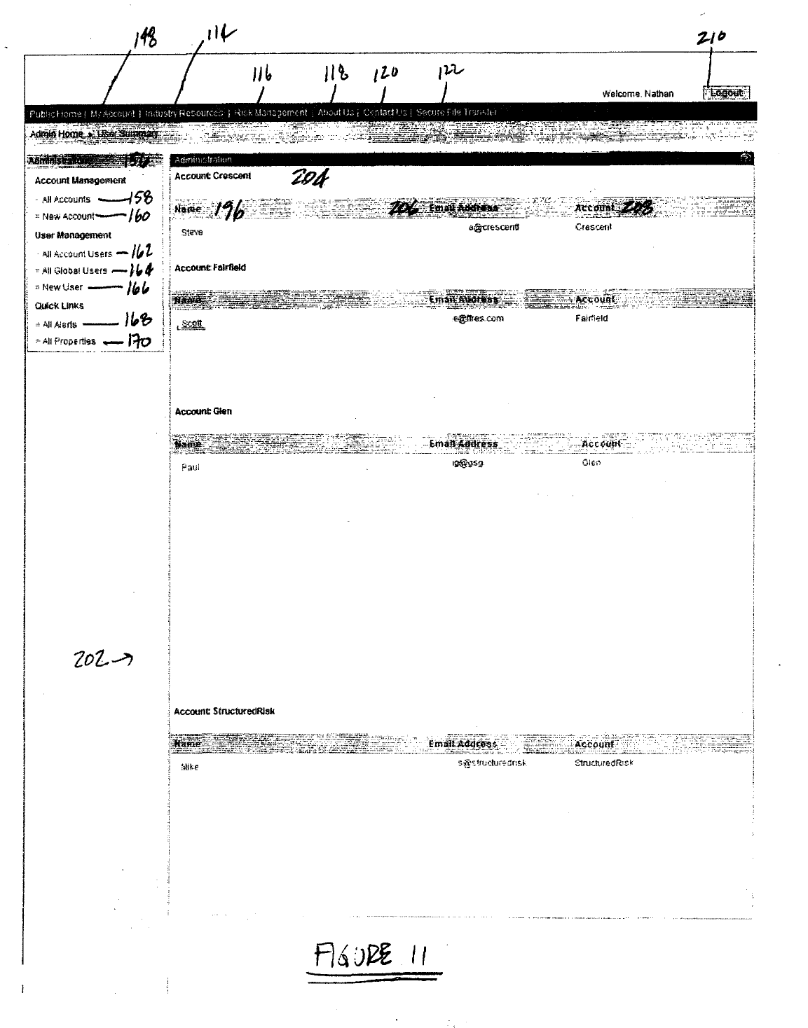

The information shown in FIG. 11 is the same information shown in FIG. 10, as described in more detail below. As such, components illustrated in FIG. 11 that are identical to components illustrated in FIG. 10, are identified using the same reference numerals used in FIG. 10.

FIG. 11 is an example embodiment of a user interface 202 displaying a User Summary page. The User Summary page contains the Administration Tool Bar 156 including links to other RMS system pages, the name of each Account 204, a Contact Name Link 196, an e-mail address link 206, an Account Name link 208 and a logout button 210.

In the example embodiment, the Administrator navigates from the Administration Home page 146 to the User Summary page. The Administrator may click on any of the links 196, 206, 208. By clicking on the Contact Name Link 196 or the e-mail address link 206, the Administrator navigates to the Compose Window page 264. By clicking on the Account Name Link 208, the Administrator navigates to the Account Summary page 380. The Administrator may also select any of the page links contained in the Administration Tool Bar 156 section to proceed directly to another page. If the Administrator desires to logout of the system while on the User Summary page, he clicks the logout button 210.

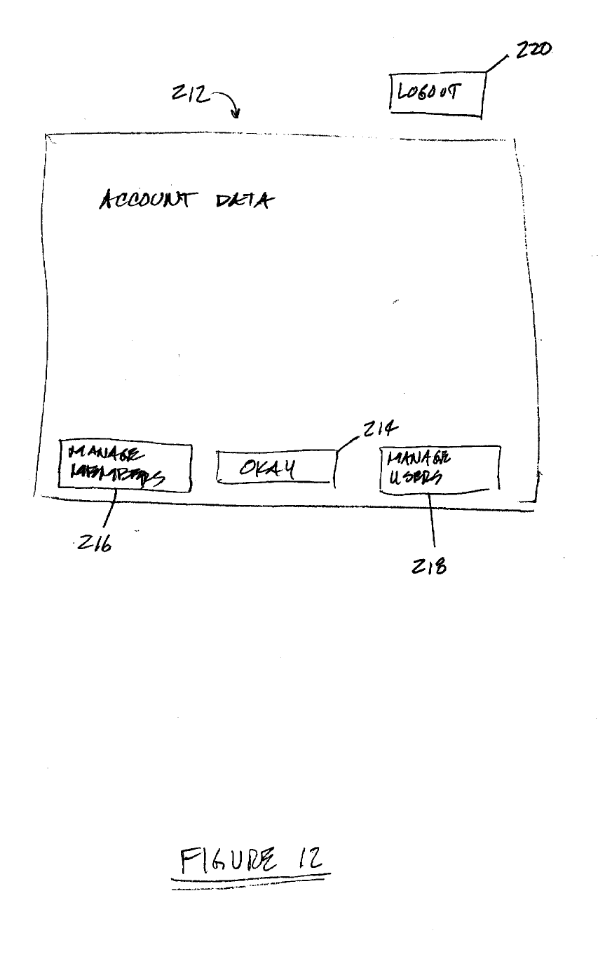

FIG. 12 is an example embodiment of a user interface 212 displaying an Edit Account Dialog form. The Edit Account Dialog form contains the selected accounts' information, an OKAY button 214, a Manage Members button 216, a Manage Users button 218, and a logout button 220.

In the example embodiment, the Administrator edits the desired information and then clicks the OKAY button 214 to save the changes. Upon clicking the OKAY button 214, the Administrator is returned to the Administration Home page 146. If the Administrator desires to exit the system while on the Edit Account Dialog form, he clicks the logout button 220.

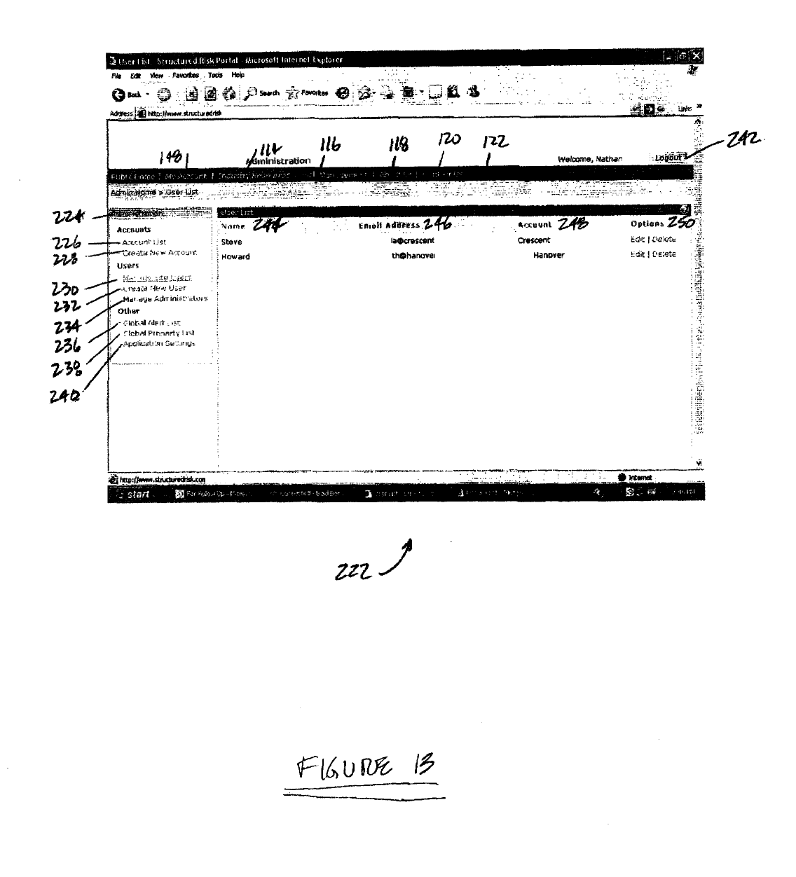

FIG. 13 is an example embodiment of a user interface 222 displaying a User List page. FIG. 13 also includes an alternative embodiment of an Administration Tool Bar 224 and associated links. Specifically, in the alternative embodiment, Administration Tool Bar 224 includes: an Account List link 226; a Create New Account link 228; a Manage Site Users link 230; a Create New User link 232; a Manage Administrators link 234; a Global Alert List link 236; a Global Property List link 238; and, an Application Settings link 240. The User List Web page also includes a logout button 242. In the User List Web page, the names 244, e-mail addresses 246, account designations 248 and options 250 are provided for each user.

In the exemplary embodiment, the Administrator navigates from the Administration Home page 146 to the Edit Account Dialog form. The Administrator then clicks on the Manage Users button 218 on the Edit Account Dialog form and is taken to the User List page where the Administrator is able to view the list of members for a listed property. The Administrator may also select any of the page links contained in the Administration Tool Bar 224 section to proceed directly to another page. Should the Administrator desire to leave the page while at the User List page, he clicks on one of the Administration Tool Bar 224 links or clicks on the logout button 242.

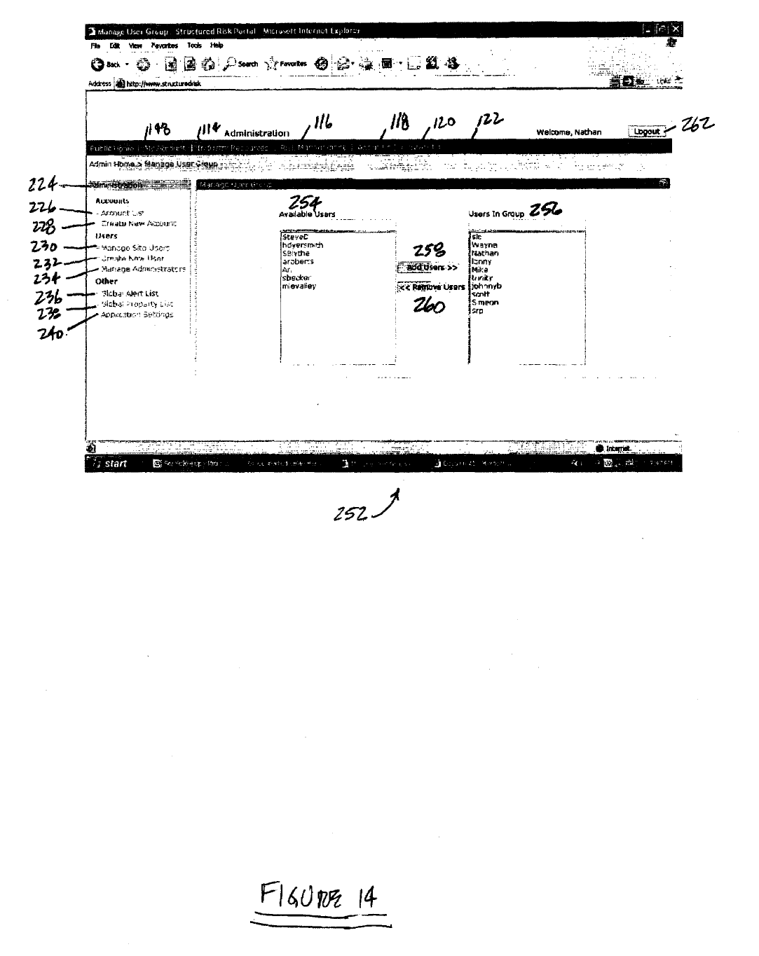

FIG. 14 is an example embodiment of a user interface 252 displaying a Manage User Group page. The Manage User Group page includes a list of Available Users 254 not yet added to the account, a list of Users in the Group 256 that are currently added or associated with the account, an Add User button 258, a Remove User button 260, the Administration Tool Bar 224 links and a logout button 262.

In the example embodiment, the Administrator navigates from the Administration Home page to the Edit Account Dialog Form. The Administrator then clicks on the Manage Members button 216 and is taken to the Manage User Group page to add a user to the Users in Group 256. The Administrator selects one of the names in the list of Available Users 254 and then clicks on the Add Users button 258. To remove a user from the Users in Group 256, the Administrator selects one of the names in the Users in Group 256 and clicks on the Remove Users button 260. The Administrator may also select any of the page links contained in the Administration Tool Bar 224 section to proceed directly to another page. Should the Administrator desire to leave the page, he clicks on one of the Administration Tool Bar 224 links or the logout button 262.

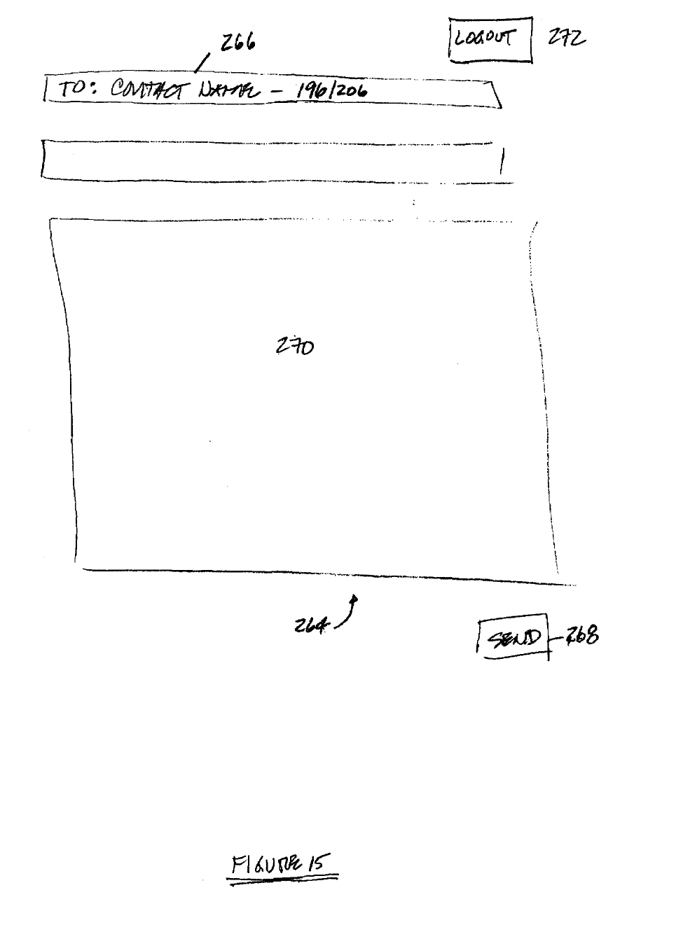

FIG. 15 is an example embodiment of a user interface 264 displaying an e-mail Compose Window page having a TO:e-mail address 266, a Send button 268 a message field 270 and a logout button 270.

In the example embodiment, the Administrator navigates to the Compose Window page. Clicking the Contact Name 196 link opens the Compose Window populated with the Contact's Name 196 and e-mail address 206 in the TO: field 266. The Administrator then types a message in the field 270 and when finished clicks on the Send button 268. Should the Administrator desire to leave the system, he clicks on the logout button 272.

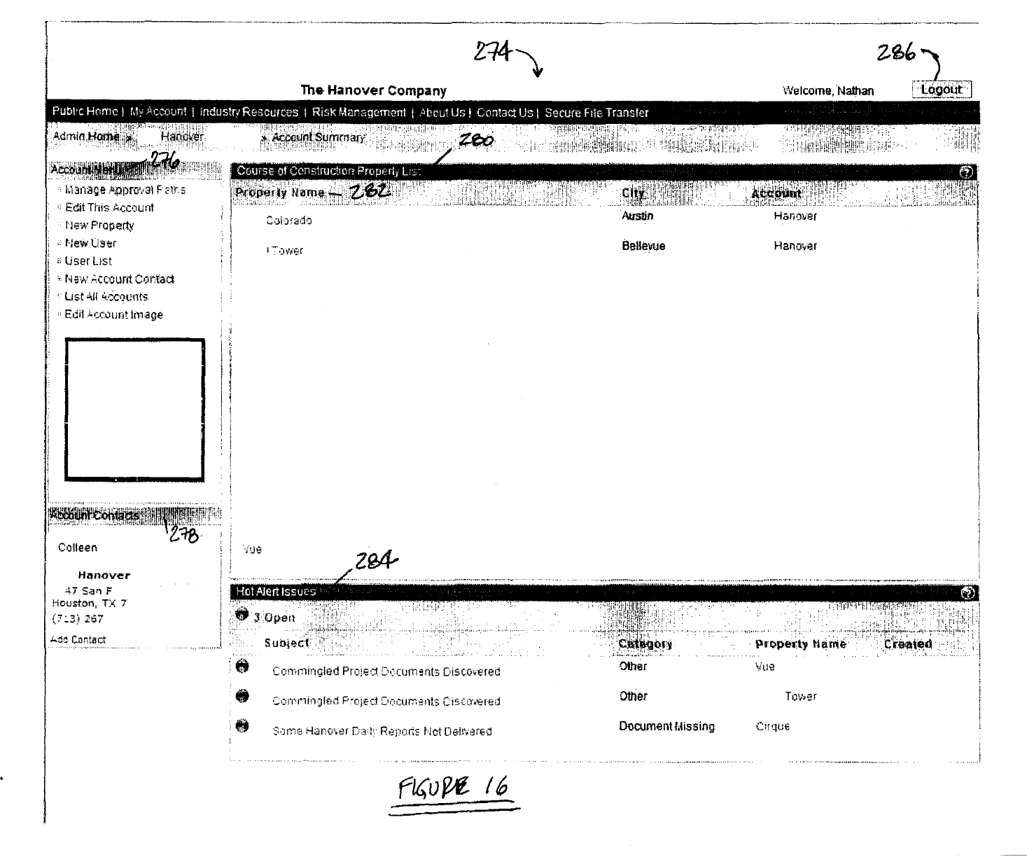

FIG. 16 is an example embodiment of a user interface 274 displaying an Account Summary page. The Account Summary page includes an Account Menu 276, an Account Contacts Section 278, a Course of Construction Property List 280 having Property Name Links 282, a Hot Alert Issues Section 284 and a logout button 286. The Account Menu Section 276 includes an Account Picture and Account Links and each property name link also shows the account and city of each property.

In the example embodiment, the Administrator navigates to open the Account Summary page. On the Account Summary page, the Administrator can view the properties in the Course-of-Construction Property List 280 and access more information regarding the property by clicking on the Property Name Link 282. The Administrator may also click on alerts contained in the Hot Alert Issues Section 284 to view more information regarding an alert. Should the Administrator desire to leave the system, he clicks on the logout button 286.

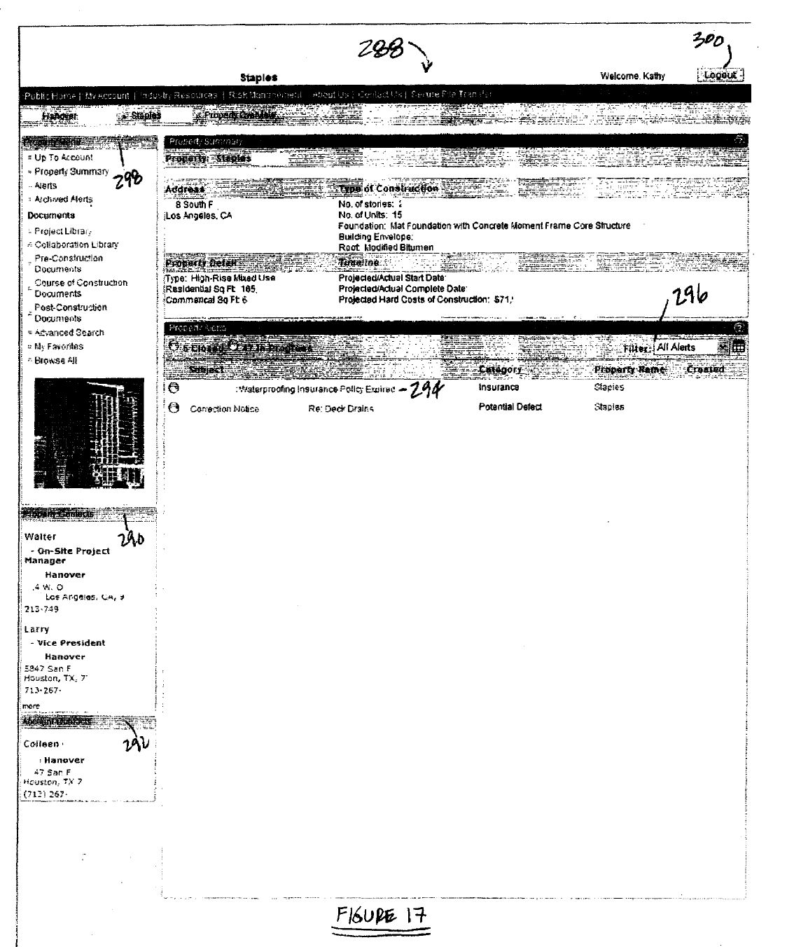

FIG. 17 is an example embodiment of a user interface 288 displaying a Property Overview page including a Property Summary Section, Property Alerts Section, a Property Contacts Section 290 and an Account Contacts Section 292. The Property Summary Section includes Property Address, Type of Construction, Property Details and a Construction Timeline for a selected property. The Property Alerts Section includes the number of alerts in progress and the number of closed alerts. Moreover, the property Alerts Section includes the subject of each alert as a link 294, the category of each alert, the Property Name associated with an alert and the date the alert was created. The Property Alerts Section also contains a filter pull-down menu 296. By clicking on the filter pull-down menu 296, the Administrator may select which alerts to show in the Property Alert Section. For example, the Administrator may choose to show all alerts, only red alerts, only yellow alerts, only green alerts, only black alerts, or any combination of alerts. This page also includes a Property Menu 298 that includes links to other RMS system pages, and a logout button 300.

In the example embodiment, the Administrator clicks on a desired alert link or toggles the filter pull-down menu 296. The Administrator may also select any of the page links contained in the Property Menu 298 section to proceed directly to another page. Should the Administrator desire to exit the system while on the Property Overview page, he clicks the logout button 300.

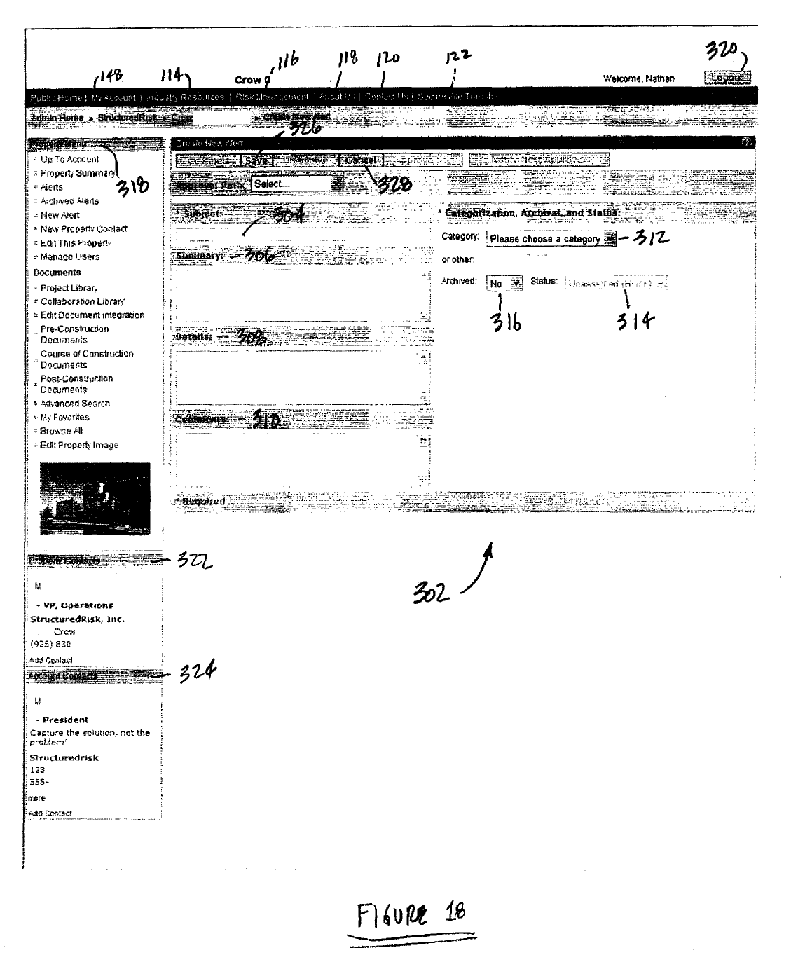

FIG. 18 is an example embodiment of a user interface 302 displaying a Create New Alert page. The Create New Alert page contains a Subject Area 304, an Alert Summary Area 306, an Alert Details Area 308, a Comments Area 310, a category pull-down menu 312, a Status pull-down menu 314, an Archive pull-down menu 316, a Property Menu Area 318, and a logout button 320. Property Menu Area 318 contains links to other pages within the RMS system. The Create New Alert page also contains a Property Contacts Section 322, an Account Contacts Section 324, a Save button 326 and a Cancel button 328.

In the example embodiment, the Administrator navigates to the Create New Alert page. An alert is created by an RMS account manager having Administration permissions with access to the RMS system. For example, the Administrator can navigate to the Account List page 192 and select a property name or account. Once in the account, the Administrator can see all pending RED alerts. Upon selecting a property name, the Administrator is provided with the corresponding Property Profile and Management page where he can view all of the alerts. To create a new alert, the Administrator clicks on the New Alert button. By clicking on the New Alert button, the Administrator navigates to the Create New Alert page and enters appropriate information.

In the example embodiment, the Administrator enters appropriate information in the corresponding areas. After entering the appropriate information in the Create New Alert areas, the Administrator also selects an alert status using the alert status pull-down menu 314. There are four levels of alert: red; yellow; green; and black. Red alert status indicates an alert is open and requires attention. Yellow alert status indicates an alert is in progress. That is, the alert has been reviewed by a client and is in progress towards resolution. Green alert status indicates an alert is closed. That is, the alert was reviewed, properly addressed, and proven closed by documentation. Black alert status indicates an alert has not been assigned red, yellow or green status. The Administrator clicks on the Save button 326 to save the entered information and create the new alert so it is viewable by the client. An Administrator may decide not to enter information by clicking on the Cancel button 328. The Administrator may also select any of the page links contained in the Property Menu 318 section to proceed directly to another page. Should the Administrator desire to exit the system while on the Create New Alert page, he clicks the logout button 320.

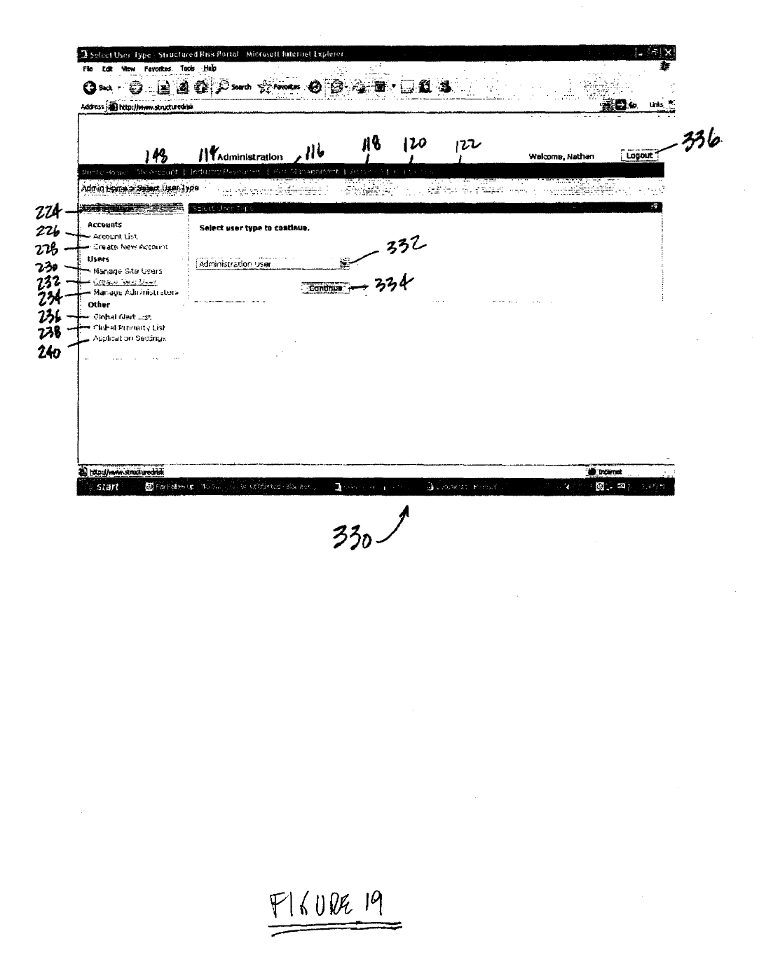

FIG. 19 is an example embodiment of a user interface 330 displaying a Select User Type page. The Select User Type page contains an Administration User pull-down menu 332, a Continue button 334, Administration Tool Bar 224 and associated links and a logout button 336.

In the example embodiment, the Administrator clicks on the Administration User pull-down menu 332 which selects the type of User or Account Name. For example, the type of user may be identified as, but not limited to, administrative, non-administrative or global. The Continue button 334 is clicked to store the selection. The Administrator may also select any of the page links contained in the Administration Tool Bar 224 section to proceed directly to another page. Should the Administrator desire to exit the system at this page, he clicks on logout button 336.

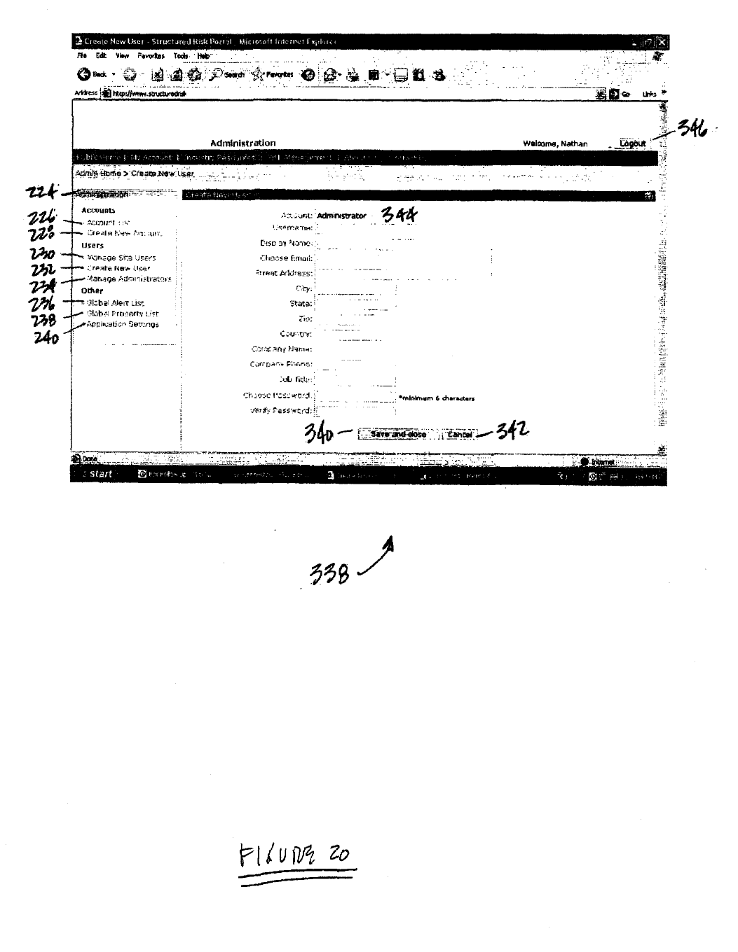

FIG. 20 is an example embodiment of a user interface 338 displaying a Create New User page for an Administrator. The Create New User page includes data fields for the Account, Username, Display Name, E-mail, Street Address, City, State, Zip Code, Country, Company Name, Company Phone, Job Title, Choose Password, and Verify Password. Further, this page contains a Save and Close button 340, a Cancel button 342, Administration Tool Bar 224 and associated links, an account heading 344 and a logout button 346.

In the example embodiment, the Administrator presses Continue button 334 on the Select User Type page to enter the type of user and to navigate to the Create New User page. The type of account appears next to the Account heading 344. The Administrator enters the appropriate information in each of the data fields. Upon completely entering the data, the Administrator clicks the Save and Close button 340 to save the entered data, thus creating a new account. An Administrator may also decide not to enter data by clicking on the Cancel button 342. Upon clicking on the Save and Close button 340 or the Cancel button 342, the system returns to the Administrator Home page. The Administrator may also select any of the page links contained in the Administration Tool Bar 224 section to proceed directly to another page. Should the Administrator desire to exit the system while on the Create New Account page, he clicks the logout button 346.

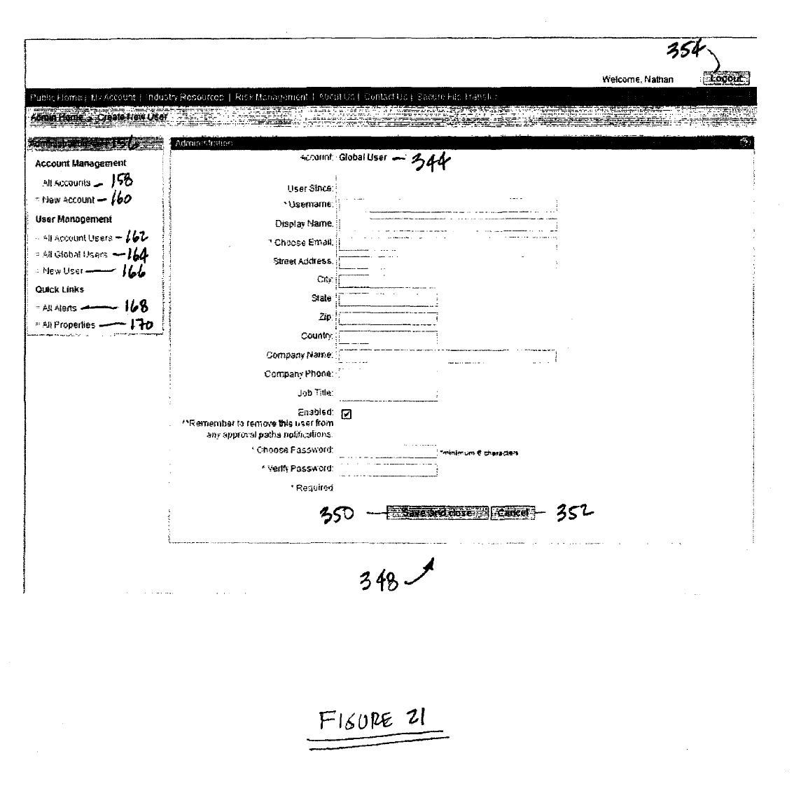

The information shown in FIG. 21 is the same information shown in FIG. 20, as described in more detail below. As such, components illustrated in FIG. 21 that are identical to components to illustrated in FIG. 21, are identified using the same reference numerals used in FIG. 21.

FIG. 21 is another example embodiment of a user interface displaying a Create New User page for a global user. The Create New User page includes data fields for the Account, Username, Display Name, E-mail, Street Address, City, State, Zip Code, Country, Company Name, Company Phone, Job Title, Choose Password, and Verify Password. Further, this page contains a Save and Close button 350, a Cancel button 352, Administration Tool Bar 156 and associated links and a logout button 354. Moreover, this page contains a checkbox for making the user inactive.

In the example embodiment, the Administrator presses Continue button 334 to enter the type of user and to navigate to the Create New user page. The type of account appears next to the Account heading 344. The Administrator enters the appropriate information in each of the data fields. Upon completely entering the data, the Administrator clicks the Save and Close button 350 to save the entered data, thus creating a new account. An Administrator may also decide not to enter data by clicking on the Cancel button 352. Upon clicking on the Save and Close button 350 or the Cancel button 352, the system returns to the Administrator Home page. An Administrator may decide to check the checkbox for enabling removal of the user from any approval path notifications. The Administrator may also select any of the page links contained in the Administration Tool Bar 156 section to proceed directly to another page. Should the Administrator desire to exit the system while on the Create New Account page, he clicks the logout button 354.

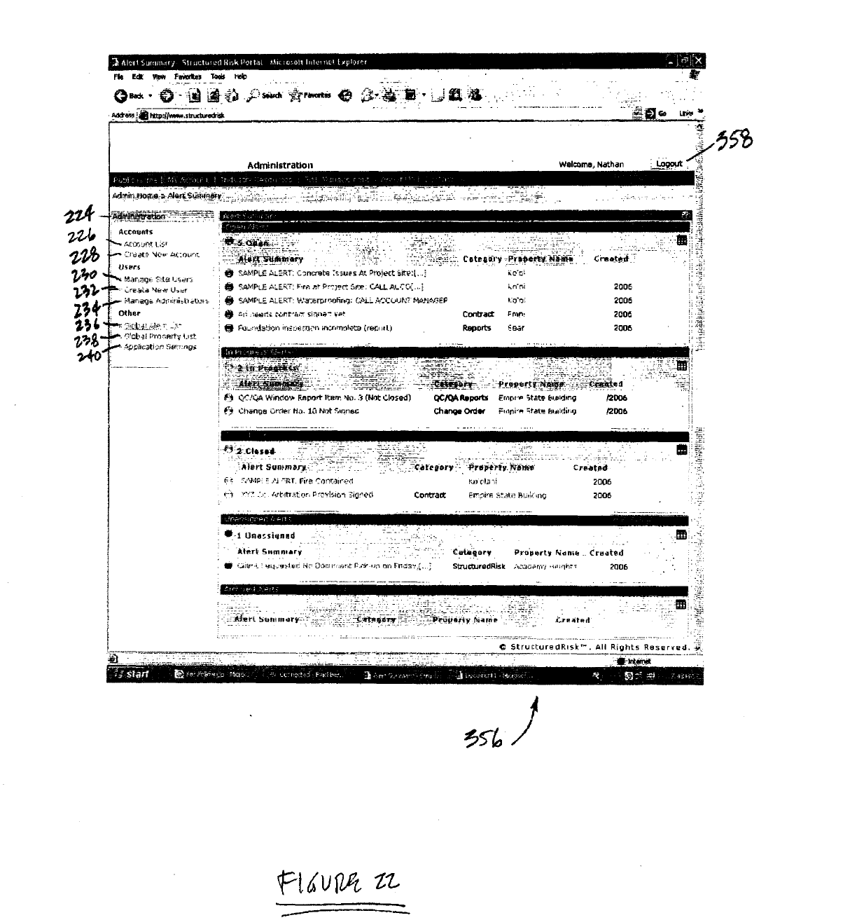

FIG. 22 is an example embodiment of a user interface 356 displaying an Alert Summary page. It includes links for several types of alerts: Open Alerts, In Progress Alerts, Closed alerts, Unassigned Alerts, and Archived Alerts. Each type of alert has a field for an Alert Summary, Category, Property Name and date created. This page also has Administration Tool Bar 224 and associated links and a logout button 358.

In the example embodiment, the Administrator views the various alerts and may click on each alert link for more detailed information. The Administrator may also select any of the page links contained in the Administration Tool Bar 224 section to proceed directly to another page. Should the Administrator desire to exit the system while on the Alert Summary page, he clicks the logout button 358.

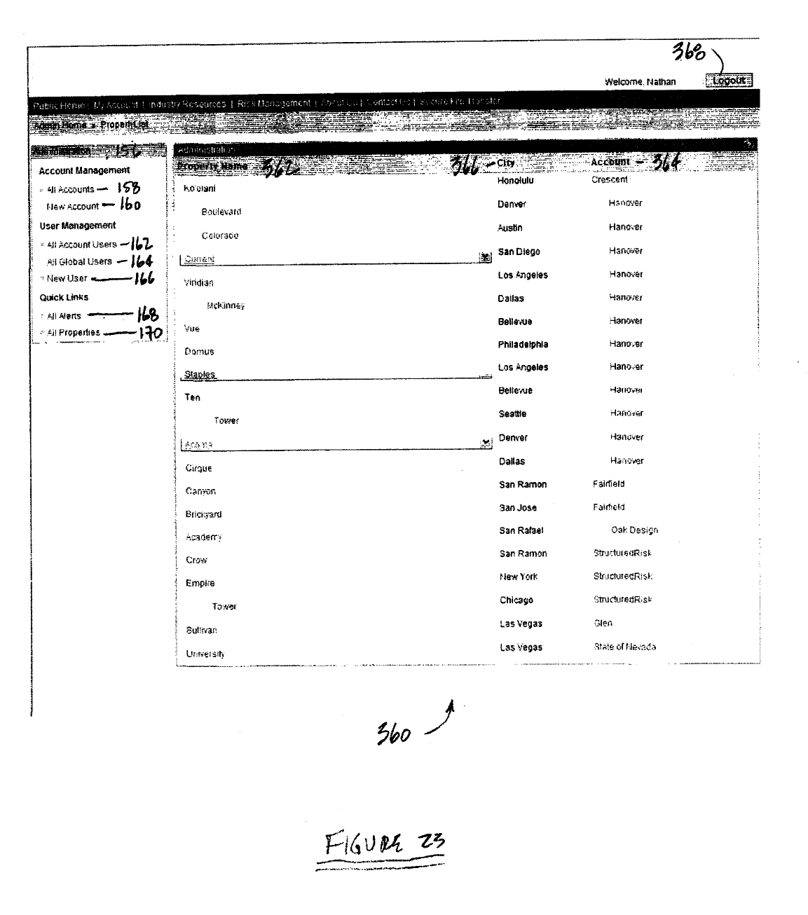

FIG. 23 is an example embodiment of a user interface 360 displaying a Property List page. It includes a list of Property Name links 362, corresponding Account links 364 and the City location 366. This page also includes Administration Tool Bar 156 and associated links and a logout button 368.

In the example embodiment, the Administrator views various Property Names and may click on a particular Property Name Link 362 to view additional information regarding the selected property. The Administrator may also select any of the page links contained in the Administration Tool Bar 156 section to proceed directly to another page. Should the Administrator desire to exit the system while on the Course-of-Construction page, the Administrator clicks logout button 368.

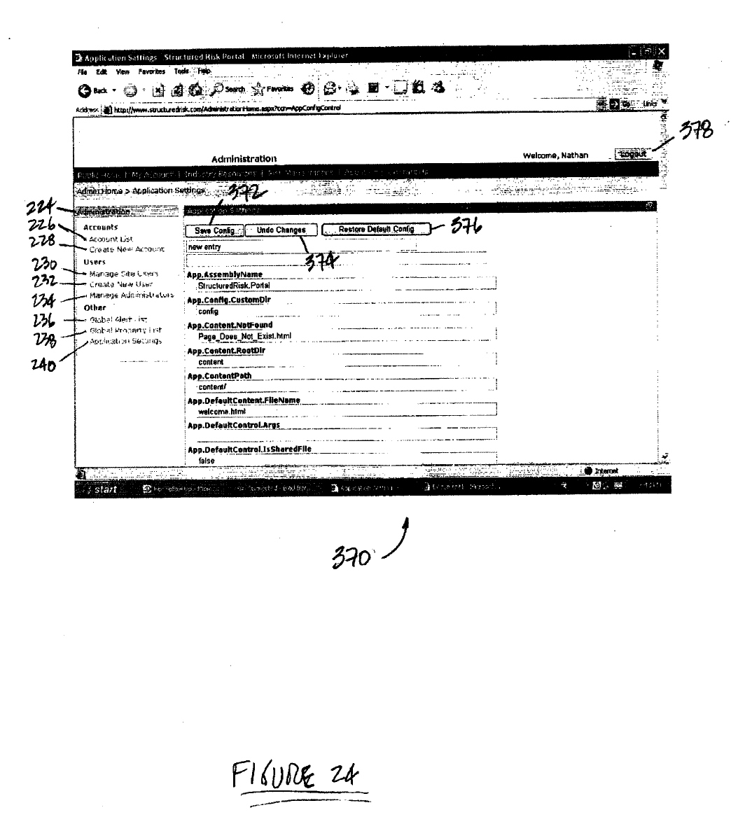

FIG. 24 is an example embodiment of a user interface 370 displaying an Application Settings page. It includes a Save Configuration button 372, an Undo Changes button 374, and a Restore Default Configuration button 376. Additionally, it contains several data fields for: App.Assembly Name; App.Config. Custom Dir; App.Content.NotFound; App.ContentRoot.Dir; App.ContentPath; App.DefaultContent.Filename; App.DefaultControl.Args; and App.DefaultControl.IsSharedFile. The Application Settings page also has Administration Tool Bar 224 Links and a logout button 378.

In the example embodiment, the Administrator may click on one of the buttons or enter data in one of the data fields. The Administrator may also select any of the page links contained in the Administration Tool Bar 224 section to proceed directly to another page. Should the Administrator desire to exit the system while on the Application Settings page, he clicks the logout button 378.

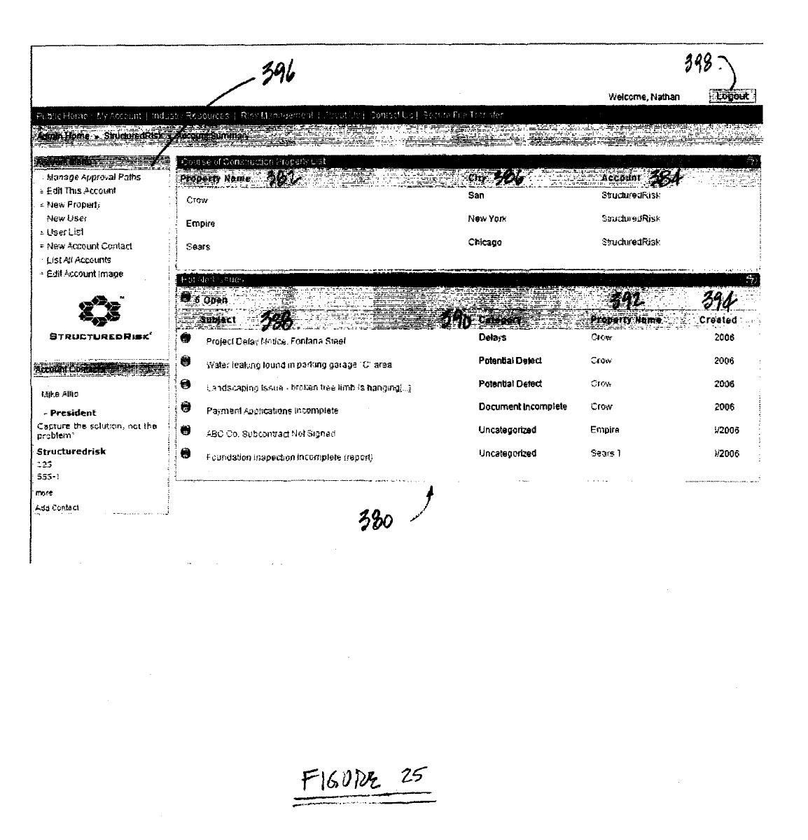

FIG. 25 is an example embodiment of a user interface 380 displaying an Account Summary page including a Course-of-Construction Property List Section and Hot Alert Issues Section for accessing the documents and alerts generated during the Course-of-Construction. The Course-of-Construction Property List Section includes a list of Property Name links 382, corresponding Account links 384, and city location 386. The Hot Alert Issues Section includes an alert Subject Link 388, an alert Category 390, a Property name Link 392 and a date the alert was created 394. This page also has an Account menu 396 that includes links to other RMS System pages, and a logout button 398.

In the example embodiment, the Administrator views various property names and may click on a particular property name link 382 to view documents or alerts generated during the Course-of-Construction for that property. By clicking on the alert Subject link 388, the Administrator may get additional alert information. The Administrator may also select any of the page links contained in the Account Menu 396 section to proceed directly to another page. Should the Administrator desire to exit the system while on the Account Summary Page, he clicks the logout button 398.

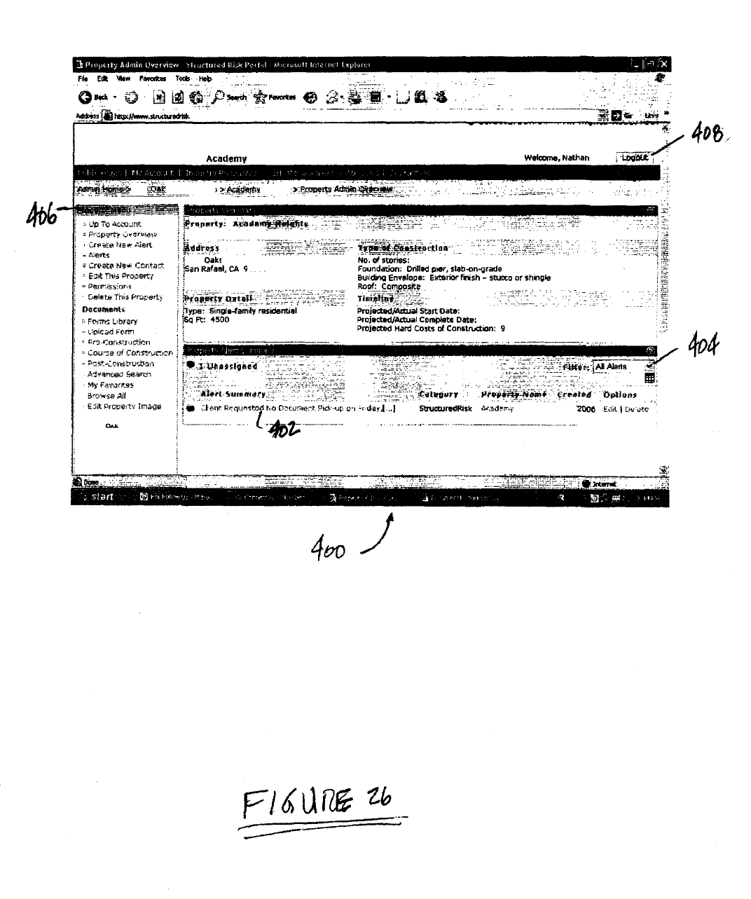

FIG. 26 is an example embodiment of a user interface 400 displaying a Property Administration Overview page including a Property Summary and a Property Alert Summary. The Property Summary contains the Address, Type of Construction, Property Detail, and Timeline for a selected property. The Property Alert Summary contains an alert link 402 and a Filter pull-down menu 404. This page also has Property Menu 406 that includes links to other RMS system pages, and a logout button 408.

In the example embodiment, the Administrator views the information presented and may click on an alert link 402 or toggle the filter pull-down menu 404. By toggling the filter pull-down menu 404, the Administrator may select which alerts to show in the Property Alert Summary. For example, the Administrator may choose to show all alerts, only red alerts, only yellow alerts, only green alerts, only black alerts, or any combination of alerts. The Administrator may also select any of the page links contained in the Property Menu 406 section to proceed directly to another page. Should the Administrator desire to exit the system while on the property Administration Overview page, he clicks the logout button 408.

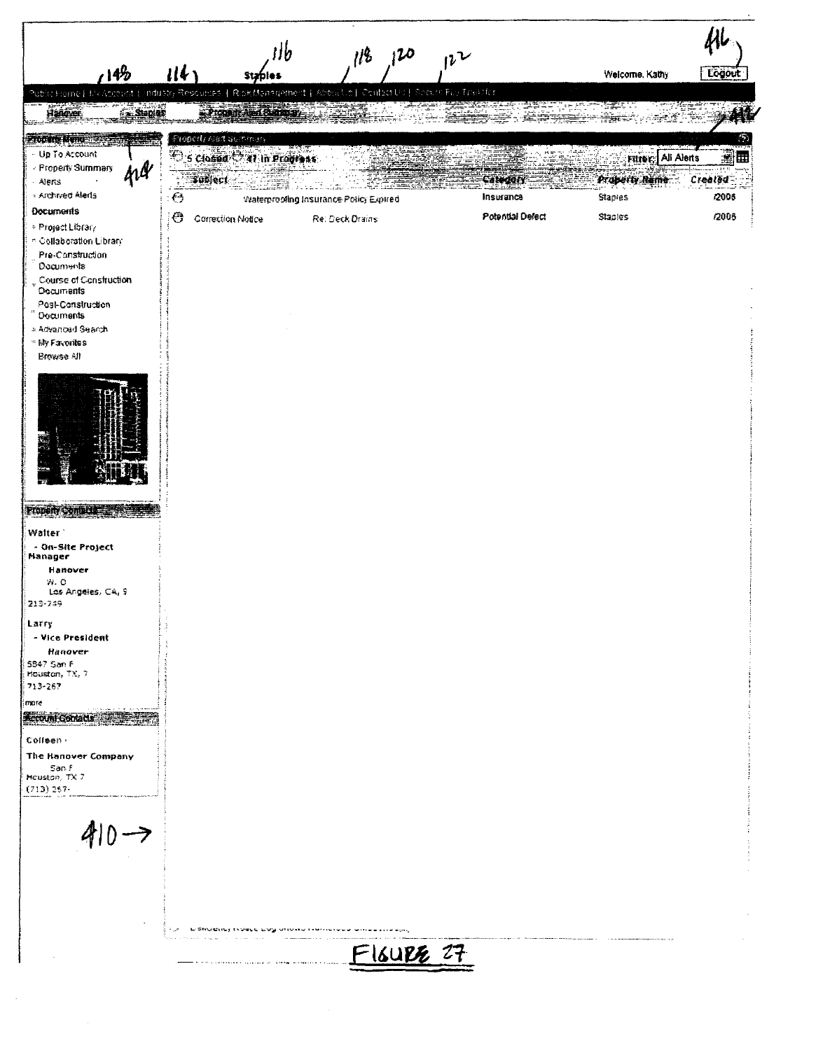

FIG. 27 is an example embodiment of a Property Alert Summary page 410. The Property Alert Summary Section includes the number of open alerts, the number of alerts in progress and the number of closed alerts. Moreover, the Property Alerts Summary Section includes the subject of each alert as a link, the category of each alert, the Property Name associated with an alert and the date the alert was created. The Property Alerts Summary Section also contains a filter pull-down menu 412. By clicking on the filter pull-down menu 412, the Administrator may select which alerts to show in the Property Alert Section. For example, the Administrator may choose to show all alerts, only red alerts, only yellow alerts, only green alerts, only black alerts, or any combination of alerts. This page also includes a Property Menu 414 that includes links to other RMS system pages, and a logout button 416.

In the example embodiment, the Administrator clicks on a desired alert link or toggles the filter pull-down menu 412. The Administrator may also select any of the page links contained in the Property Menu 414 section to proceed directly to another page. Should the Administrator desire to exit the system while on the Property Overview page, he clicks the logout button 416

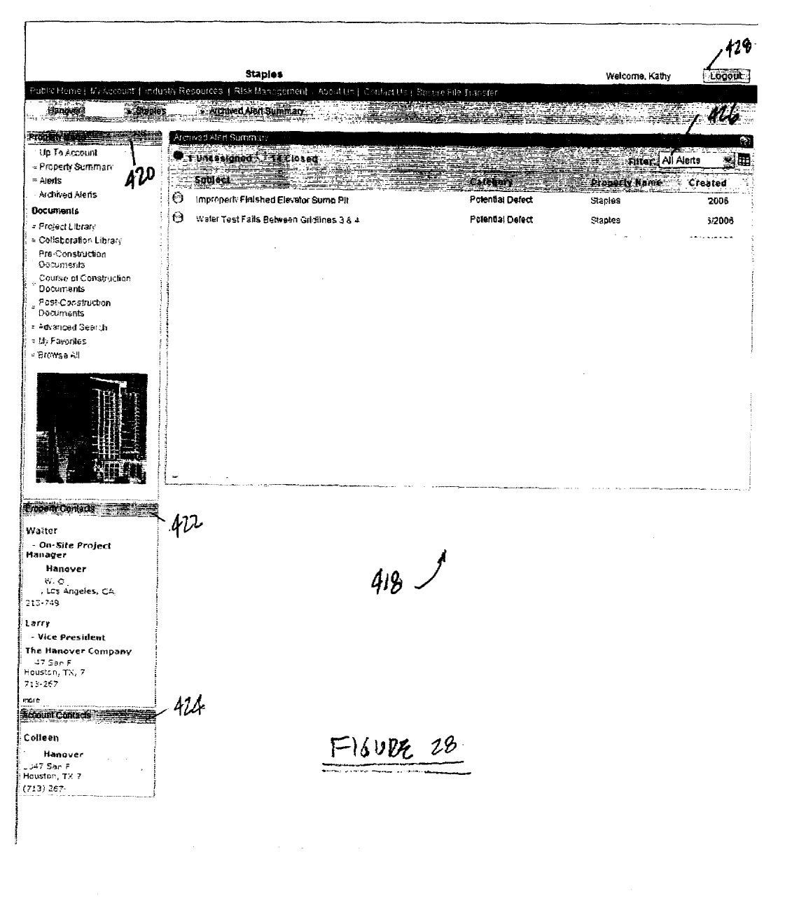

FIG. 28 is an example embodiment of a user interface 418 displaying an Archived Alert Summary. The Archived Alert Summary page includes a Property Menu 420 that includes links to other RMS system pages, a Property Contacts Section 422 and an Account Contacts Section 424. The Archived Alert Summary Section includes a number of unassigned Archived Alerts and a number of closed Archived Alerts. Moreover, the Archived Alert Summary Section includes the subject of each alert as a link, the category of each alert, the Property Name associated with an alert and the date the alert was created. The Archived Alerts Summary Section also contains a filter pull-down menu 426. Filter pull-down menu 426 contains options for red, yellow and green alerts. By clicking on the filter pull-down menu 426, the Administrator may select which alerts to show in the Archived Alert Summary Section. The Archived Alert Summary Page 418 also includes a logout button 428.

In the example embodiment, the Administrator clicks on a desired alert link for additional information about the alert, or toggles the filter pull-down menu 426. The Administrator may also select any of the page links contained in the Property Menu 420 section to proceed directly to another page. Should the Administrator desire to exit the system while on the Archived Alert Summary page, he clicks the logout button 428.

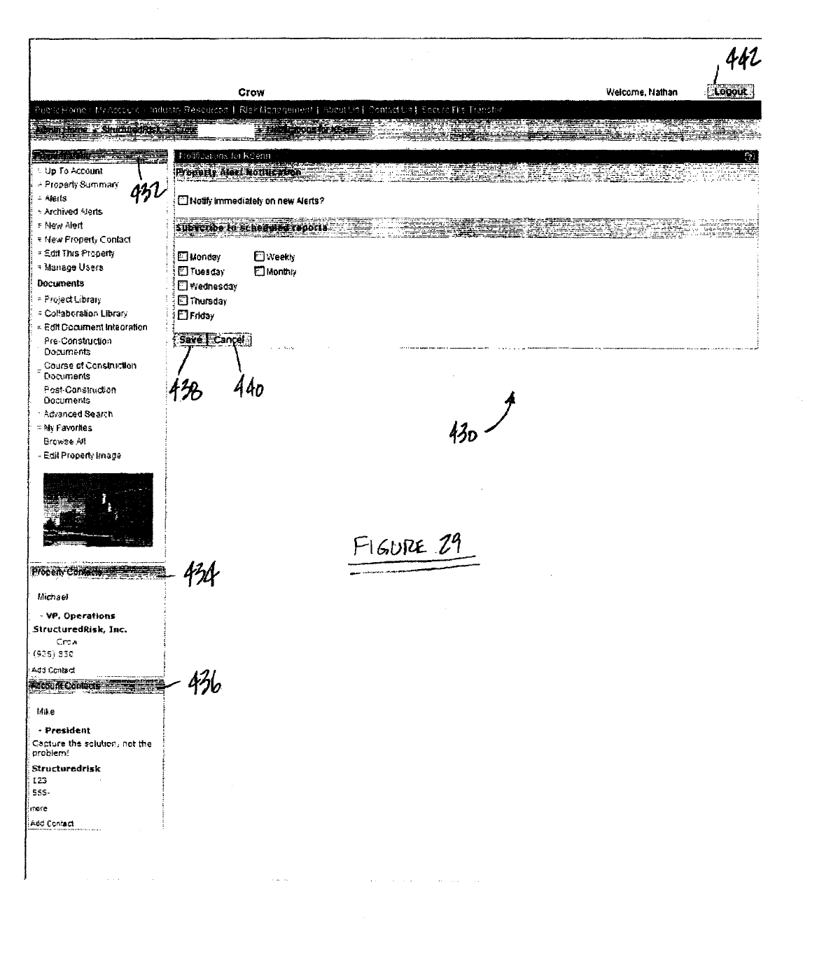

FIG. 29 is an example embodiment of a user interface 430 displaying a Property Alert Notification page for a user named Kevin Senn. More specifically, the Property Alert Notification page includes a Property Alert notification Section, a Scheduled Reports Section, a Property Menu 432 that includes links to other RMS system pages, a Property Contacts Section 434, an Account Contacts Section 436, a Save button 438, a Cancel Button 440 and a Logout Button 442. The Property Alert Notification Section includes a checkbox for immediate notification of new alerts. The Scheduled Reports Section includes checkboxes for days of the week, Monday through Friday, and for Weekly or Monthly.

In the exemplary embodiment the Administrator checks the Alert Notification Section to receive immediate notification of any alerts, and checks a box or boxes corresponding to the desired times the Administrator desires to receive reports. After checking the desired boxes, the Administrator clicks on the Save button 438 to save the checked selections. If the Administrator decides not to save the checked boxes, he clicks on the Cancel button 440. The Administrator may also select any of the page links contained in the Property Menu 432 section to proceed directly to another page. Should the Administrator desire to exit the system while on the Notification page, he clicks the logout button 442.

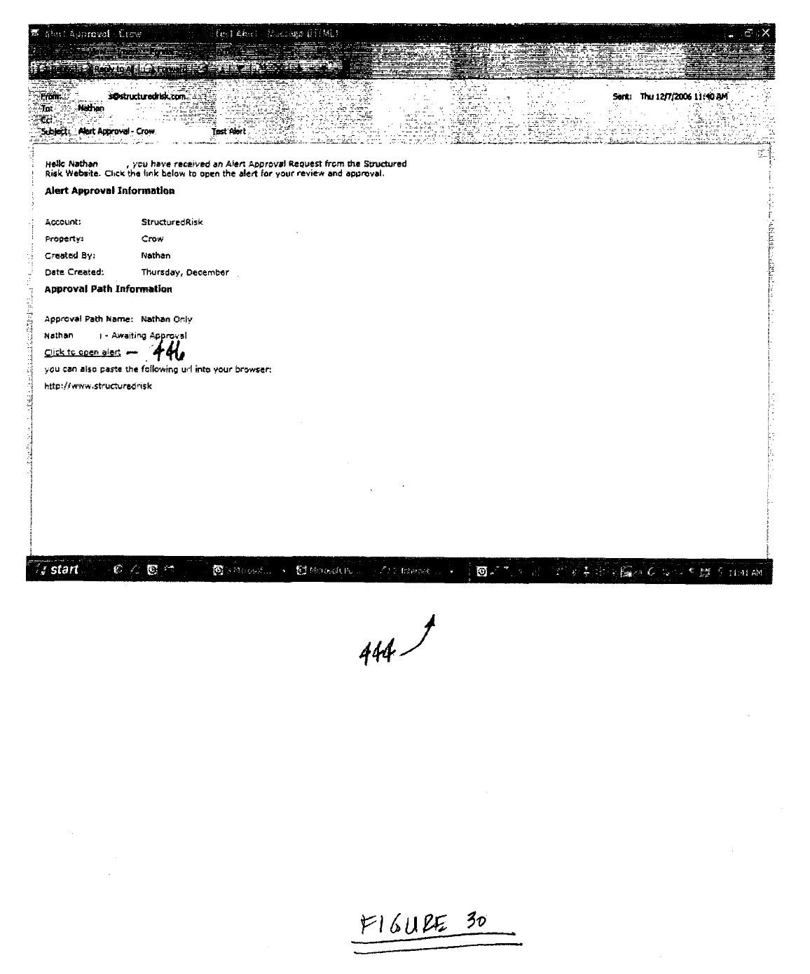

FIG. 30 is an example embodiment of a use interface 444 displaying an Alert Approval Request page. More specifically, the Alert Approval Request page is an e-mail received from the operator of the RMS System notifying an Administrator, in this case Nathan Scheg, that an alert is ready for his review and approval. The Alert Approval Request page includes an Alert Approval Information Section and an Approval Path Information Section. The Alert Approval Information Section includes the account the alert applies to, the property the alert applies to, who created the alert, and the date the alert was created. The Approval Path Information Section includes the approval path name, and the status of the approval. The Alert Approval Message page also includes a link 446 to open the alert.

In the example embodiment, the individual receiving the Alert Approval Request clicks on link 446 to open the alert, review the alert and otherwise act on the alert.

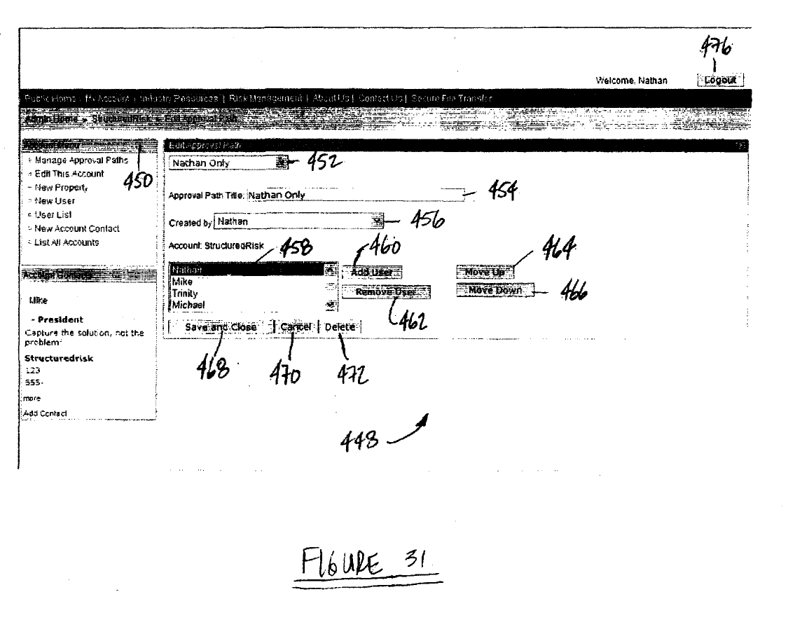

FIG. 31 is an example embodiment of a use interface 448 displaying an Edit Approval Path page. More specifically, the Edit Approval Path page includes an Account Menu 450 that includes links to other RMS system pages, a pull-down menu 452, an Approval Path Title 454, a pull-down menu 456, a user menu 458, an Add User button 460, a Remove User button 462, a Move Up button 464, a Move Down button 466, a Save and Close button 468, a Cancel button 470 and a Delete button 472. The Edit Approval Path page also includes an Account Contacts Section 474 and a logout button 476.

In the example embodiment, the Administrator navigates to the Edit Approval page through the Administrative Home page and the RMS system provider. The Administrator uses this screen to set-up a path of Administrators required to approve an alert before it is published on the RMS system. After the alert receives all proper approvals, it is distributed on the RMS system so that appropriate users may view the alert. Should the Administrator desire to exit the system while on the Edit Approval Path page, he clicks the logout button 476.

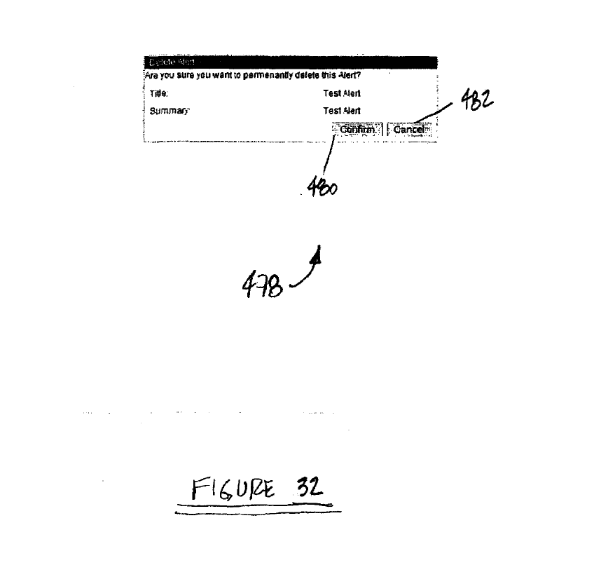

FIG. 32 is an example embodiment of a use interface 478 displaying a Delete Alert page. More specifically, the Delete Alert page 478 includes a message asking if the alert should be permanently deleted, and includes an Alert Title and an Alert Summary. Moreover, Delete Alert page 478 includes a Confirm button 480 and a Cancel button 482.

In the example embodiment, the Administrator navigates to the Delete Alert page 478. The Administrator clicks on the Confirm button 480 to permanently delete the alert, or alternatively, clicks on the Cancel button 482 to keep the alert.

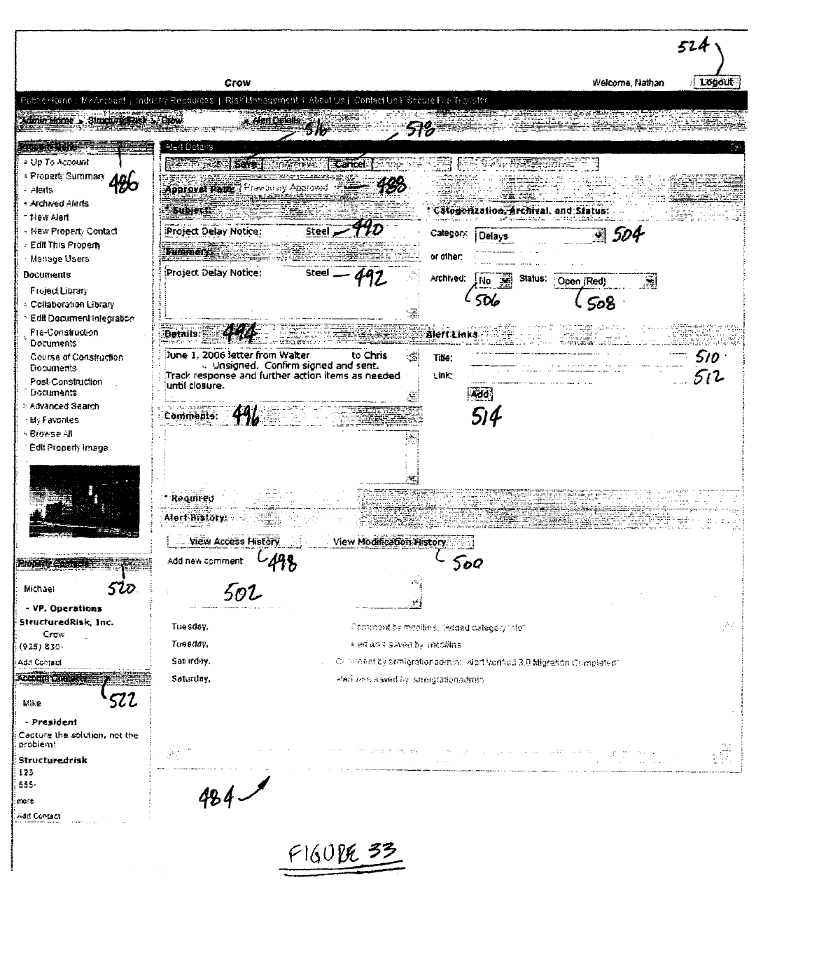

FIG. 33 is an example embodiment of a use interface 484 displaying an Alert Approval page. More specifically, the Alert Approval page includes a Property Menu 486 that includes links to other RMS system pages, an Approval Path pull-down menu 488, a Subject Section 490, a Summary Section 492, a Details Section 494, a Comments Section 496, a View Access History button 498, a View Modification History button 500, a New Comment Section 502, a Category pull-down menu 504, an Archived pull-down menu 506, a Status pull-down menu 508, a Title Section 510, a Link Section 512, an Add button 514, a Save button 516 and a Cancel button 518. The Alert Details page also includes a Property Contacts Section 520, an Accounts Contacts Section 522 and a logout button 524.

In the example embodiment, the Administrator navigates to the Alert Approval page by selecting one of the alerts from the Property Alert Summary page. The Approval Path pull-down menu 488 indicates whether the alert has been previously approved. The Subject Section 490 includes a brief description of the alert issue and the associated company or project. The Details Section 494 includes a description of the alert and action taken regarding the alert. Comments Section 496 includes comments an Administrator may feel are necessary regarding the alert. The Administrator toggles the Category pull-down menu 504 to identify an issue, such as, but limited to, project delays. The Administrator may also toggle the Archived pull-down menu 506 to identify whether or not the alert has been archived. Additionally, the Administrator may toggle the Status Section pull-down menu 508 to identify the status of the alert. The Administrator may also add a title and an associated link in the Title Section 510 and the Link Section 512, respectively, by clicking on the Add button 514. Moreover, the Administrator may view the access and modification histories of the alert by clicking on the View History button 498 and the View Modification History button 500. If the Administrator desires to add a new comment he may do so in the Add New Comment Section 502. After making changes to Alert Approval page 484, the Administrator may save them by clicking on the Save button 516 or may cancel them by clicking on the Cancel button 518. The Administrator may also select any of the page links contained in the Property Menu 486 section to proceed directly to another page. Should the Administrator desire to exit the system while on the Alert Approval page, he clicks the logout button 524.

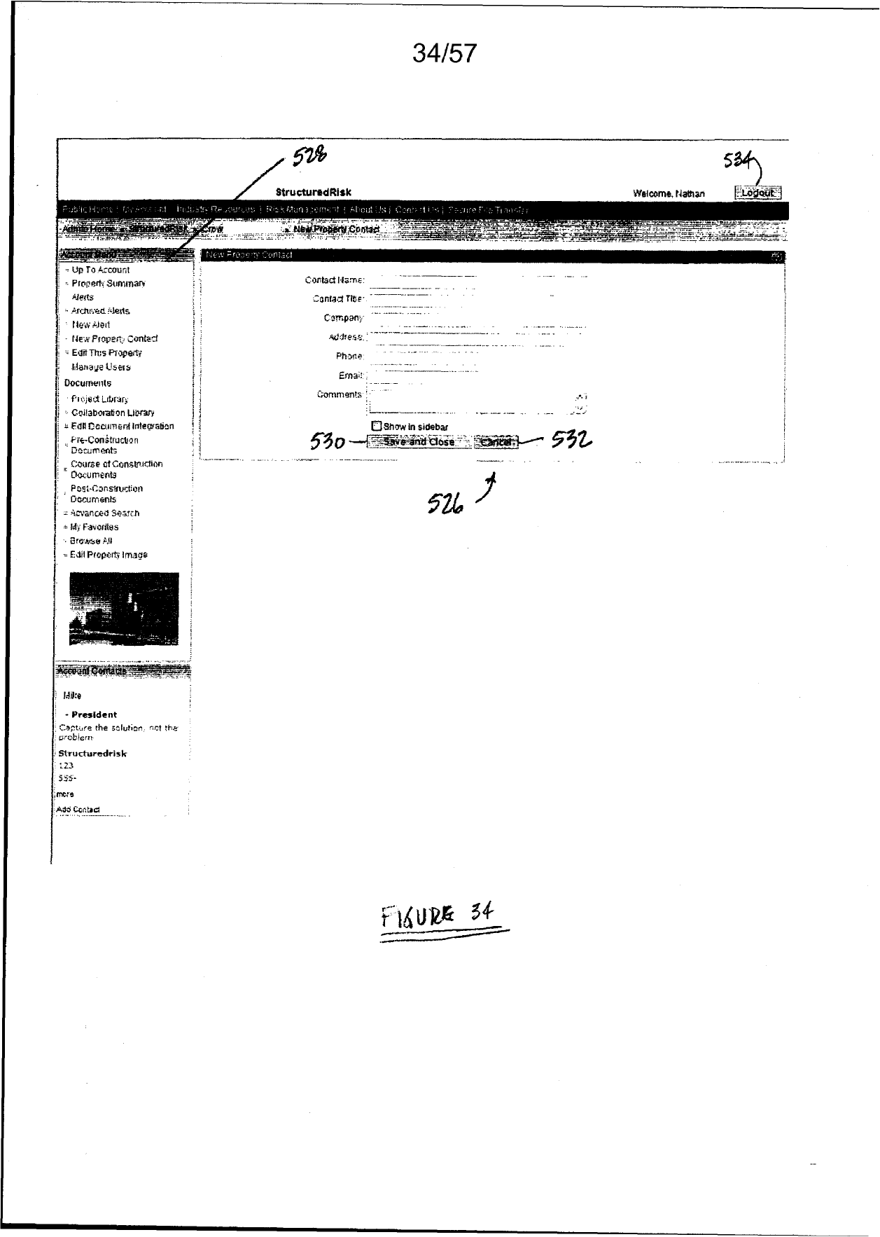

FIG. 34 is an example embodiment of a user interface 526 displaying a New Property Contact page. The New Property Contact page has data fields for the Contact Name, Contact Title, Company, Address, Phone, E-mail, Comments, an Account menu 528 that includes links to other RMS system pages, a Save and Close button 530 and a Cancel button 532. The New Property Contact Page also includes a logout button 534.

In the example embodiment, the Administrator enters the appropriate information in each of the data fields. Upon completely entering the data, the Administrator clicks the Save and Close button 530 to save the entered data, thus creating a new property contact. An Administrator may also decide not to enter data by clicking on the Cancel button 532. The Administrator may also select any of the page links contained in the Account Menu 528 section to proceed directly to another page. Should the Administrator desire to exit the system while on the New Property Contact page, he clicks the logout button 534.

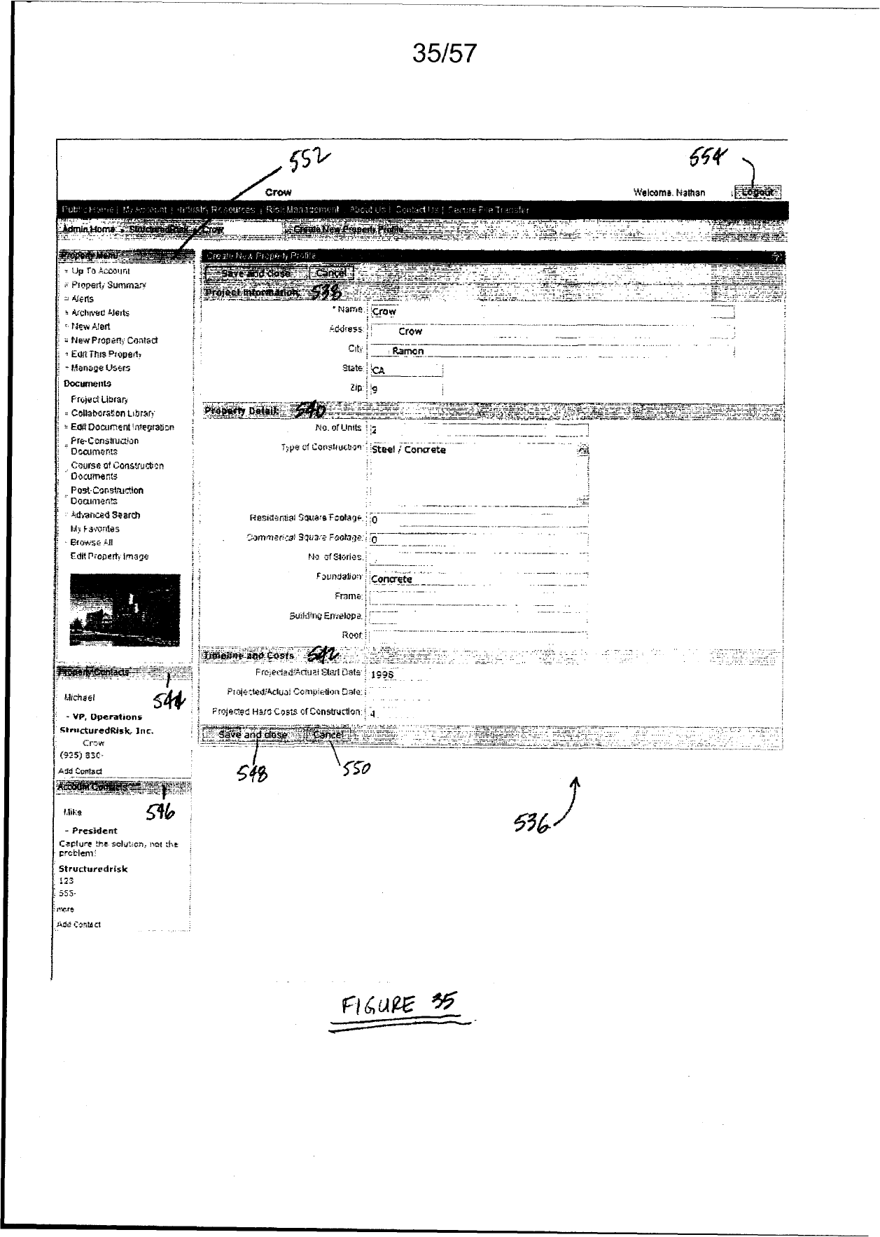

FIG. 35 is an example embodiment of a user interface 536 displaying a Create New Property Profile page. The Create New Property Profile page has a Project Information Section 538, a Property Detail Section 540 and a Timeline and Costs Section 542. The Project Information Section 538 has data fields for the Name, Address, City, State, and Zip Code. The Property Details Section 540 has data fields for the number of units, the Type of Construction, Residential Designation, Square Footage, No. of Stories, Foundation, Frame, Building Envelope and Roof. The Timeline and Costs Section 542 includes data fields for Projected/Actual Start Date, Projected/Actual Completion Date and Projected Hard Costs of Construction. This page also contains a Property Contacts Section 544, an Account Contacts Section 546, a Save and Close button 548, a Cancel button 550, Property Menu 552 that includes links to other RMS system pages and a logout button 554.

In the example embodiment, the Administrator enters the appropriate information in each of the data fields. Upon completely entering the data, the Administrator clicks the Save and Close button 548 to save the entered data, thus creating a New Property Profile. An Administrator may also decide not to enter data by clicking on the Cancel button 550. The Administrator may also select any of the page links contained in the Property Menu 552 section to proceed directly to another page. Should the Administrator desire to exit the system while on the Create New Property Profile page, he clicks the logout button 554.

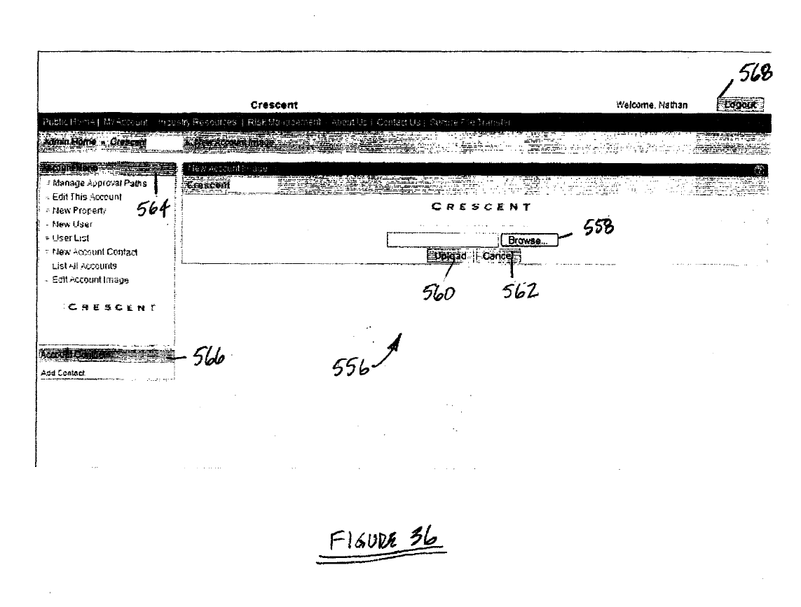

FIG. 36 is an example embodiment of a user interface 556 displaying a New Account Image page. The New Account Image page includes a Browse button 558, an Upload button 560, a Cancel button 562, an Account Menu 564 that includes links to other RMS system pages, and an Account Contacts Section 566. The New Account Image page also includes a logout button 568.

In the example embodiment, the Administrator navigates to the New Account Image page from the Administration Home page for a particular project. The Administrator clicks on the Browse button 558 to view all the available images and clicks on the Upload button 560 to load a particular image into the New Account Image page 556. Should the Administrator decide not to upload a new image, he may click on the Cancel button 562. The Administrator may also select any of the page links contained in the Account Menu 564 section to proceed directly to another page. Should the Administrator desire to exit the system while on the New Account Image page 556, he clicks the logout button 568.

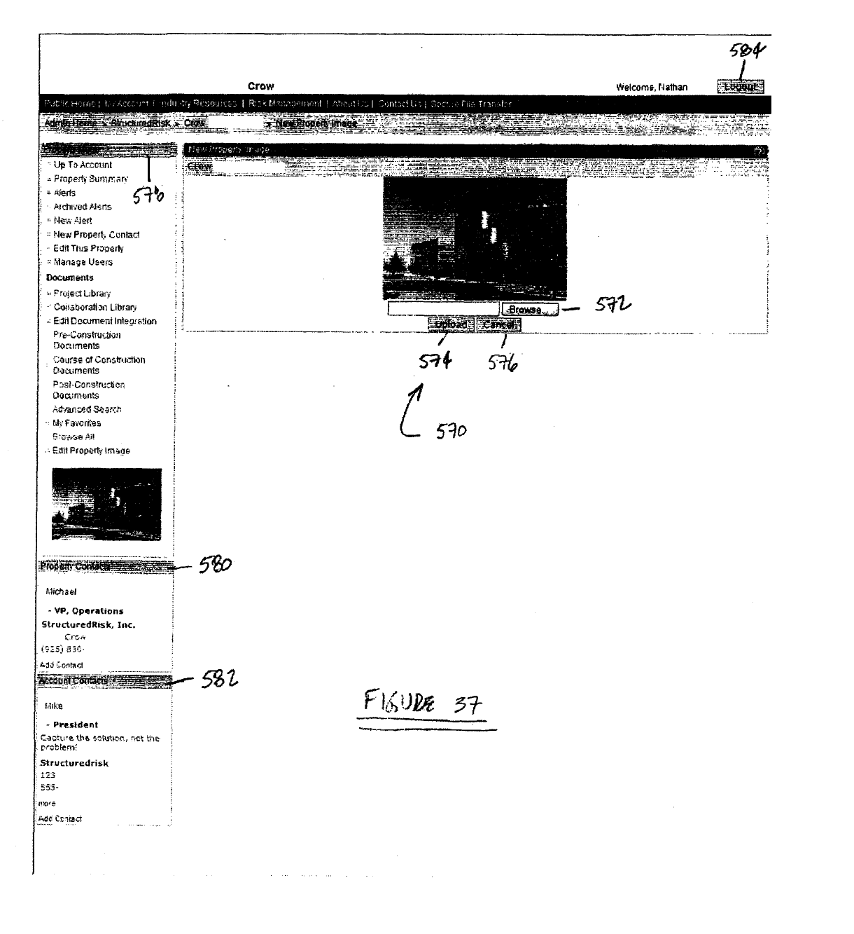

FIG. 37 is an example embodiment of a user interface 570 displaying a New Property Image page. The New Property Image page includes a Browse button 572, an Upload button 574, a Cancel button 576, a Property Menu 578 that includes links to other RMS system pages, a Property Contacts Section 580 and an Account Contacts Section 582. The New Property Image page also includes a logout button 584.

In the example embodiment, the Administrator navigates to the New Property Image page from the Administration Home page for a particular project. The Administrator clicks on the Browse button 572 to view all the available images and clicks on the Upload button 574 to load a particular image. Should the Administrator decide not to upload a new image, he may click on the Cancel button 576. The Administrator may also select any of the page links contained in the Property Menu 578 section to proceed directly to another page. Should the Administrator desire to exit the system while on the New Property Image page 570, he clicks the logout button 584.

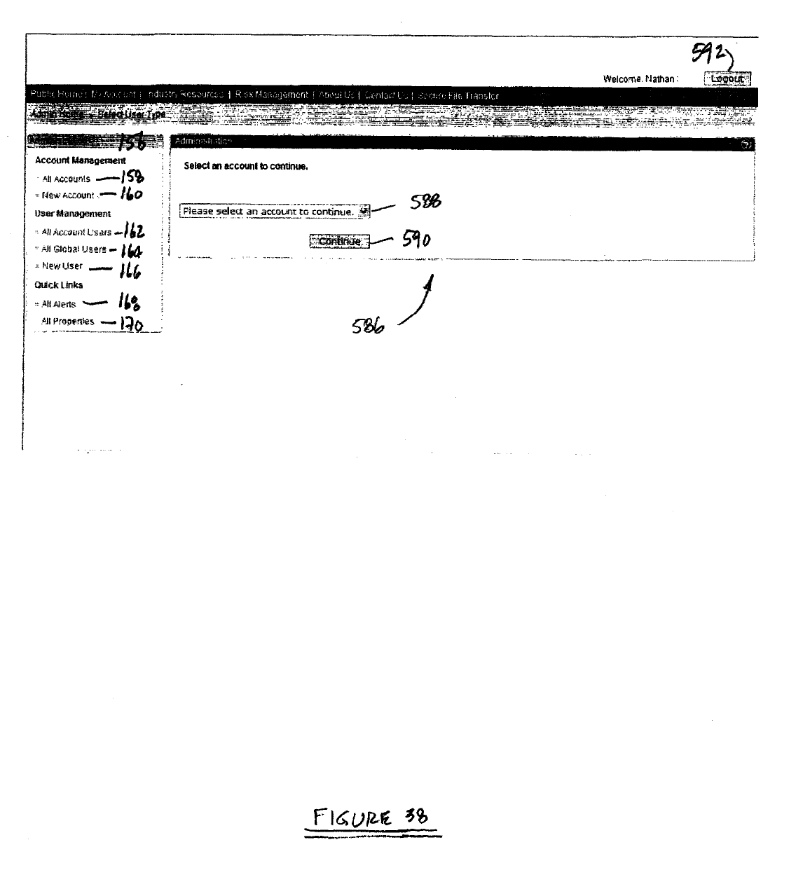

FIG. 38 is an example embodiment of a user interface 586 displaying a Select User Account page. The Select User Account page includes a pull-down menu 588, a Continue button 590, an Administration Tool Bar 156 and associated links and a logout button 592.

In the example embodiment, the Administrator navigates to the Select User Type page from a page for adding users. In order to add a user to a specific account, the Administrator toggles the pull-down menu 588 and chooses an account. By clicking on the Continue button 590, the Administrator enters the account selection for a user. The Administrator may also select any of the page links contained in the Administration Tool Bar 156 section to proceed directly to another page. Should the Administrator desire to exit the system while on the Select User Type page 586, he clicks the logout button 592.

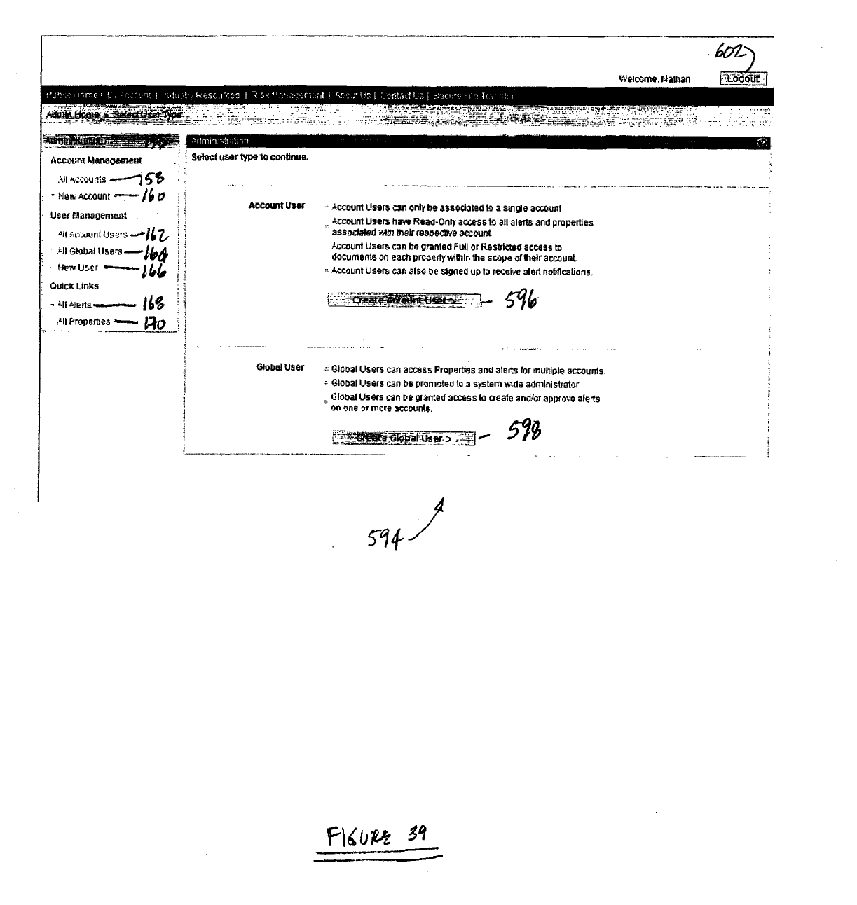

FIG. 39 is an example embodiment of a user interface 594 displaying another Select User Type page. The Select User Type page 594 includes a Select User Type Section that includes a Create Account User button 596 and a Create Global User 598. The Select User Type page also includes an Administration Menu 600 that includes links to other RMS system pages and a logout button 602.

In the example embodiment, the Administrator navigates to the Select User Type page 594. The Administrator creates a type of user by clicking on the Create Account User button 596 to create an Account User, or clicks on the Create Global User button 598 to create a Global User. The Administrator may also select any of the page links contained in the Administration Tool Bar 156 section to proceed directly to another page. Should the Administrator desire to exit the system while on the Select User Type page 594, he clicks the logout button 602.

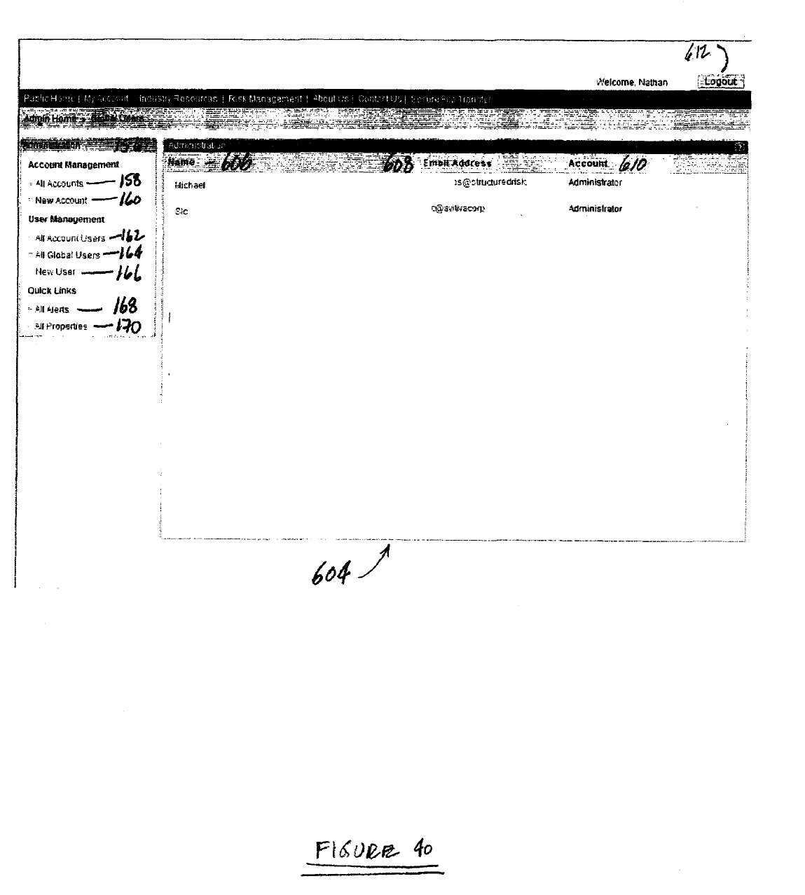

FIG. 40 is an example embodiment of a user interface 604 displaying a Global User page. The Global User page 604 includes a listing of the Name links 606, e-mail addresses 608 and associated Account 610 for each global user. The Global User page also includes an Administration Tool Bar 156 and associated links and a logout button 612.

In the example embodiment, the Administrator navigates to the Global User page 604 from the Administration Home page. The Administrator selects a particular global user by clicking on the Name link 606. The Administrator may also select any of the page links contained in the Administration Tool Bar 156 section to proceed directly to another page. Should the Administrator desire to exit the system while on the Global Users page 604, he clicks the logout button 612.

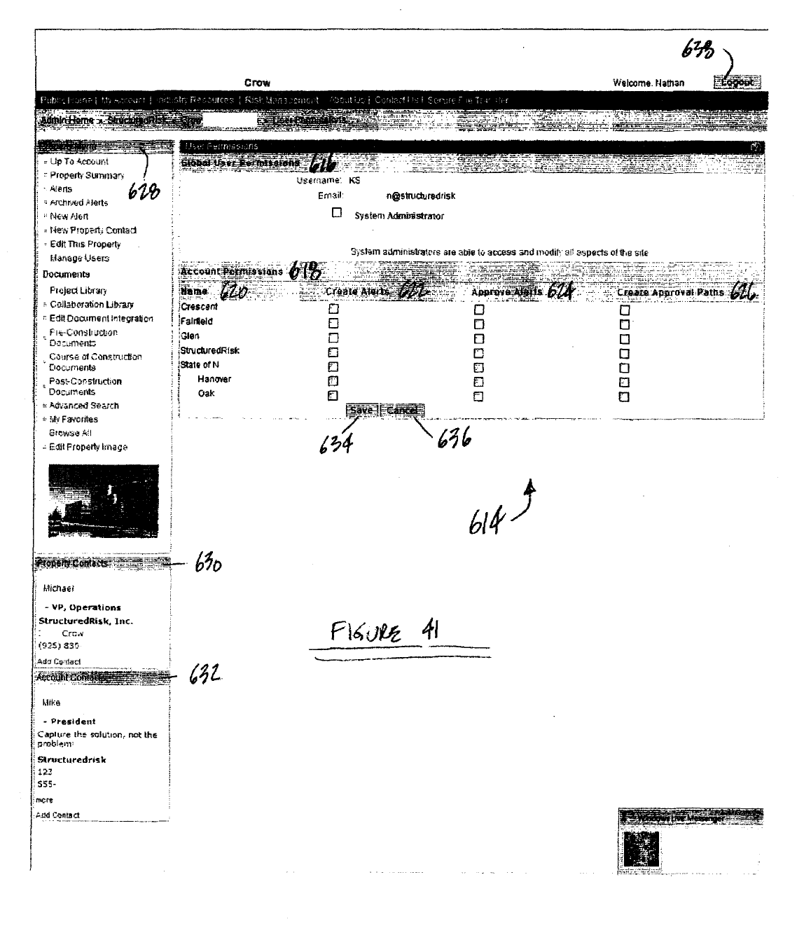

FIG. 41 is an example embodiment of a user interface 614 displaying a User Permissions page. The User Permissions page 614 includes a Global User Permissions Section 616 and an Account Users Permissions Section 618. The Global User Permissions Section 616 includes the usemame for the global user, the e-mail address of the global user and a checkbox for designating the global user as an Administrator. The Account User Permissions Section 618 includes the Account Names 620, and checkboxes for designating the Account user as able to Create Alerts 622, Approve Alerts 624 and Create Approval Paths 626. The User Permissions page also includes a Property Menu 628 that includes links to other RMS system pages, a Property Contacts Section 630, an Account Contacts Section 632, a Save button 634, a Cancel button 636 and a logout button 638.

In the example embodiment, the Administrator navigates to the User Permissions page 614. The Administrator clicks on the system Administrator checkbox to give the global user Administration permissions. Should the Administrator navigate to the User Permissions page from an Account Users page, the Administrator would click on each box (i.e. Create Alerts 622, Approve Alerts 624, Create Approval Paths 626) corresponding to desired permissions for each Account Name 620. The Administrator may also select any of the page links contained in the Property Menu 628 section to proceed directly to another page. Should the Administrator desire to exit the system while on the Users Permissions page 614, he clicks the logout button 638.

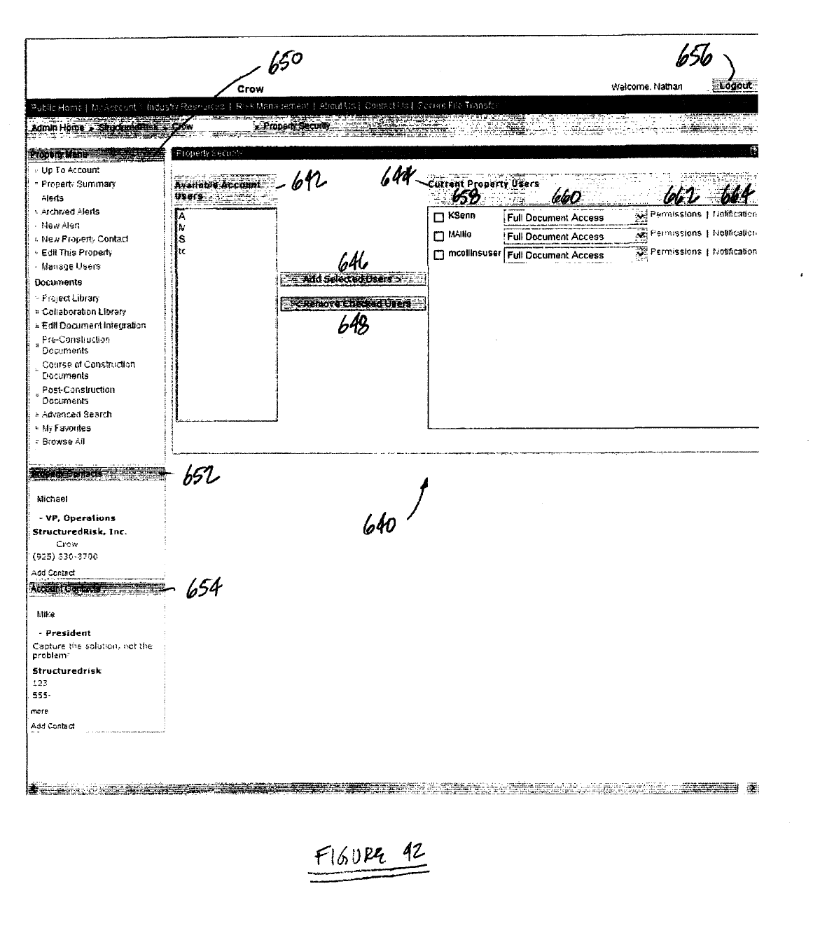

FIG. 42 is an example embodiment of a user interface 640 displaying a Property Security page. The Property Security page includes a list of Available Account Users 642 not yet added to the account, a list of Current Property Users list 644 that are currently added or associated with the account, an Add Selected Users button 646, a Remove Checked Users button 648, Property Menu 650 that includes links to other RMS system pages, a Property Contacts Section 652, an Account Contacts Section 654 and a logout button 656. The Current Property Users List 644 includes a checkbox next to each user name 658, a pull-down menu 660 corresponding to each name, a permissions link 662 corresponding to each name and a notification link 664 corresponding to each name.

In the example embodiment, the Administrator adds a person to the Current Property Users list 644 by selecting one of the names in the list of Available Account Users 642 and clicking on the Add Selected Users button 646. To remove a user from the Current Property Users list 644, the Administrator selects the checkbox corresponding to one of the names 658 in the Current Property Users list 644 and clicks on the Remove Checked Users button 648. The Administrator may also select any of the page links contained in the Property Menu 650 section to proceed directly to another page. Should the Administrator desire to leave the system, he clicks on the logout button 656.

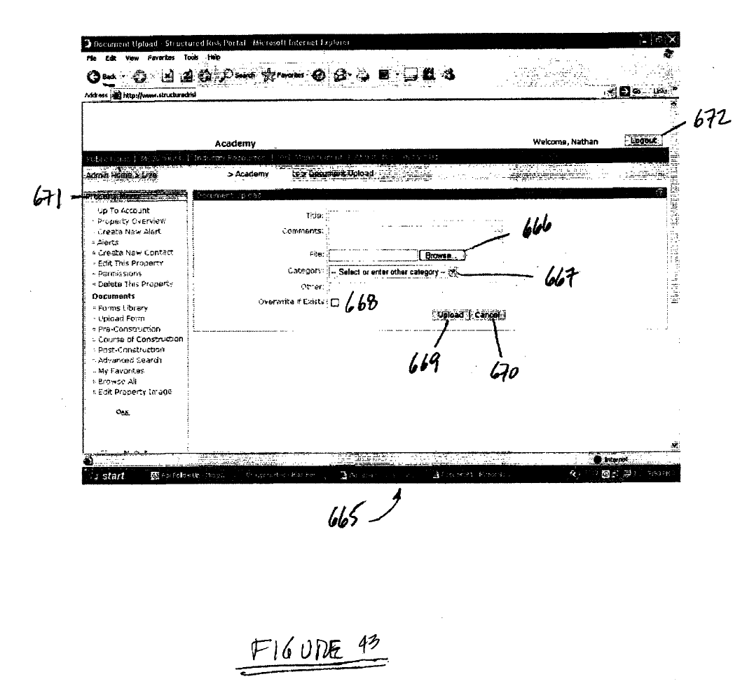

FIG. 43 is an example embodiment of a user interface 665 displaying a Document Upload page. The Document Upload page has data fields for a Title, Comments, Filename, and other. This page also includes a Browse button 666, a Select or enter other Category pull-down menu 667, an Overwrite if Exists checkbox 668, an Upload button 669, a Cancel button 670, Property Menu 671 that includes links to other RMS system pages and a logout button 672.

In the example embodiment, the Administrator enters the appropriate information in each of the data fields. To find a Filename the Administrator clicks on the Browse button 666. The Administrator can also check the Overwrite box if it exists. Upon entering all the data, the Administrator clicks the Upload button 669 to upload the entered data. An Administrator may also decide not to upload a file/data by clicking on the Cancel button 670. The Administrator may also select any of the page links contained in the Property Menu 671 section to proceed directly to another page. Should the Administrator desire to exit the system while on the Document Upload page 665, he clicks the logout button 672.

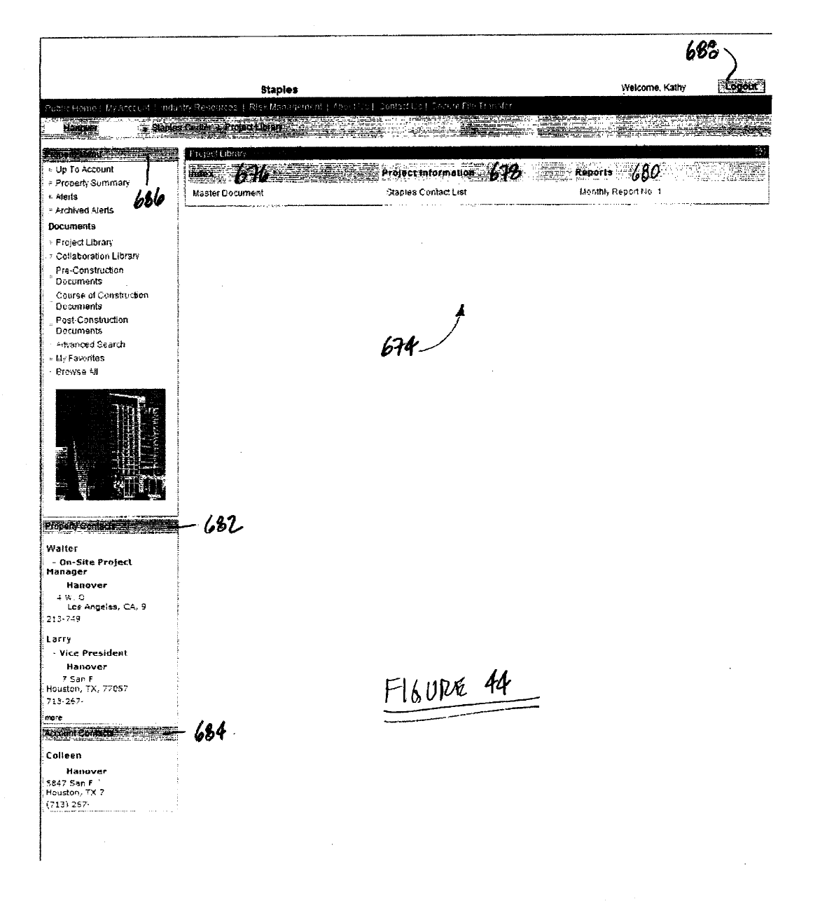

FIG. 44 is an example embodiment of a user interface 674 displaying a Project Library page. The Project Library page includes an Index Section 676 containing a master document index link, a Project Information Section 678 containing a contact list link, a Reports Section 680 including links to reports, a Property Contacts Section 682, an Account Contacts Section 684, a Property Menu 686 that includes links to other RMS system pages and a logout button 688.

In the example embodiment, the Administrator clicks on the appropriate link for more information. The Administrator may also select any of the page links contained in the Property Menu 686 section to proceed directly to another page. Should the Administrator desire to exit the system while on the Project Library page 674, he clicks the logout button 688.

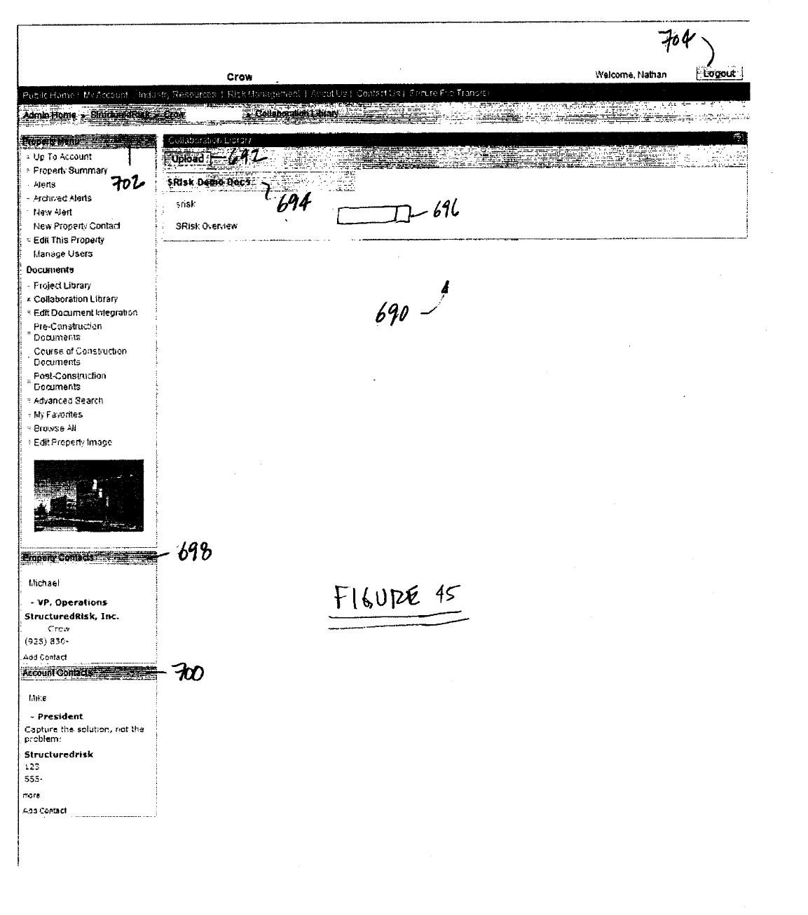

FIG. 45 is an example embodiment of a user interface 690 displaying a Collaboration Library page. The Collaboration Library page includes an Upload button 692, a Documents Section 694, a pull-down menu 696 that lists all versions of a chosen document, a Property Contacts Section 698, an Account Contacts Section 700, a Property menu 702 that includes links to other RMS system pages and a logout button 704.

In the example embodiment, a user chooses a document and then clicks on the Upload button 692 to access all versions of the chosen document. The user toggles pull-down menu 696 to choose a version of the document to access, and may modify the chosen document to create and save a new version of the chosen document. Moreover, the user may select previous versions of the document for editing or deleting. The user may also select any of the page links contained in the Property Menu 702 section to proceed directly to another page. Should the user desire to exit the system while on the Collaboration Library page 690, he clicks the logout button 704.

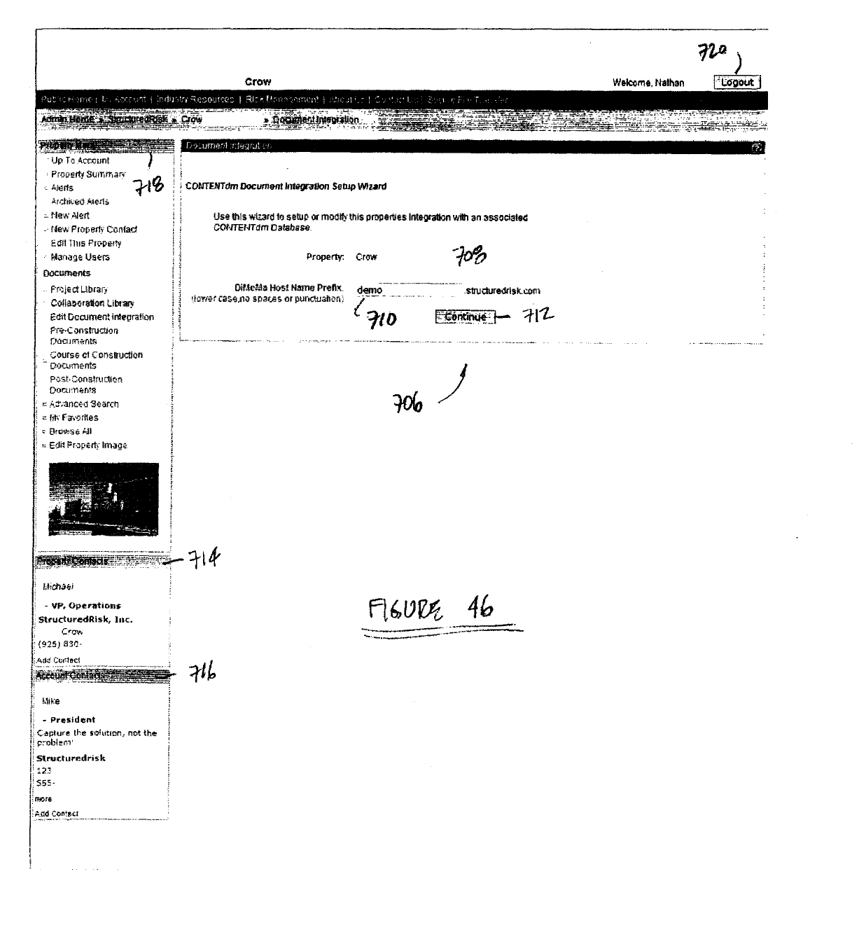

FIG. 46 is an example embodiment of a user interface 706 displaying a Document Integration page. The Document Integration page includes a Property field 708, a Host Name Prefix section 710, a Continue button 712, a Property Contacts page 714, an Account Contacts section 716, a Property Menu 718 that includes links to other RMS system pages and a logout button 720.

In the example embodiment, the Administrator enters a filename in the Host Name Prefix Section 710. By Clicking on the Continue button 712 the Administrator sets up or modifies the properties integration with an associated Database. The Administrator may also select any of the page links contained in the Property Menu 718 section to proceed directly to another page. Should the Administrator desire to exit the system while on the Document Integration page 706, he clicks the logout button 720.

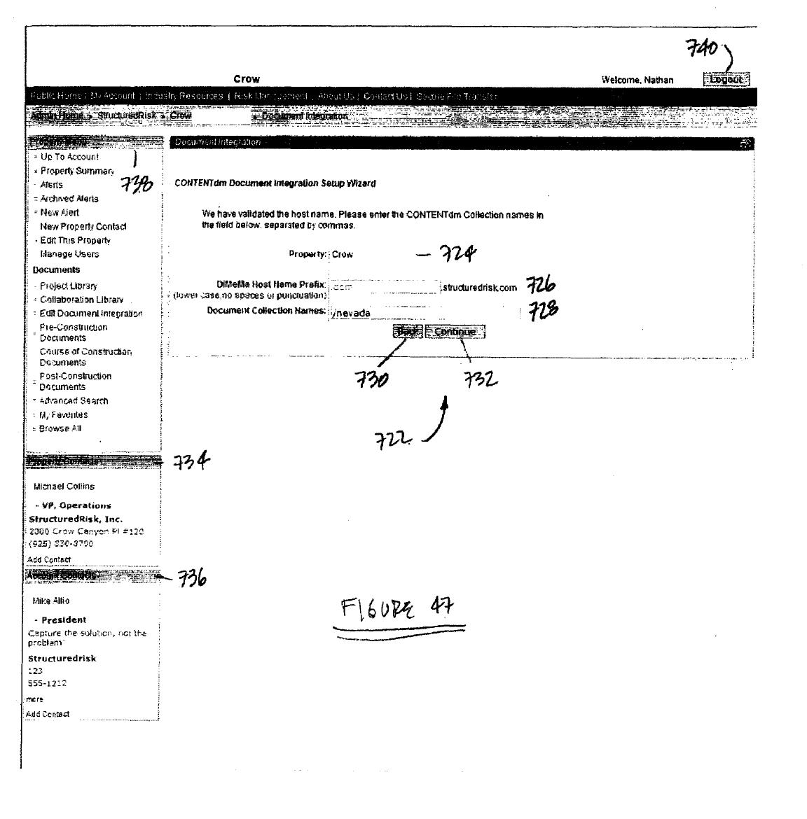

FIG. 47 is another example embodiment of a user interface 722 displaying another Document Integration Page. The Document Integration page includes a Property field 724, a Host Name Prefix Section 726, a Document Collection Name Field 728, a Back button 730, a Continue button 732, a Property Contacts Section 734, an Account Contacts Section 736, a Property Menu 738 that includes links to other RMS system pages and a logout button 740.

In the example embodiment, the Administrator navigates to Document Integration page 722 by clicking on Continue button 712 of Document Integration page 706. The Administrator enters the CONTENTdm Collection names in the Document Collection Names Field 728 and clicks on Continue button 712 to navigate to Document Integration page 722. By Clicking on the Back button 730, the Administrator navigates back to the Document Integration page 722. The Administrator may also select any of the page links contained in the Property Menu 738 section to proceed directly to another page. Should the Administrator desire to exit the system while on the Document Integration page 722, he clicks the logout button 740.

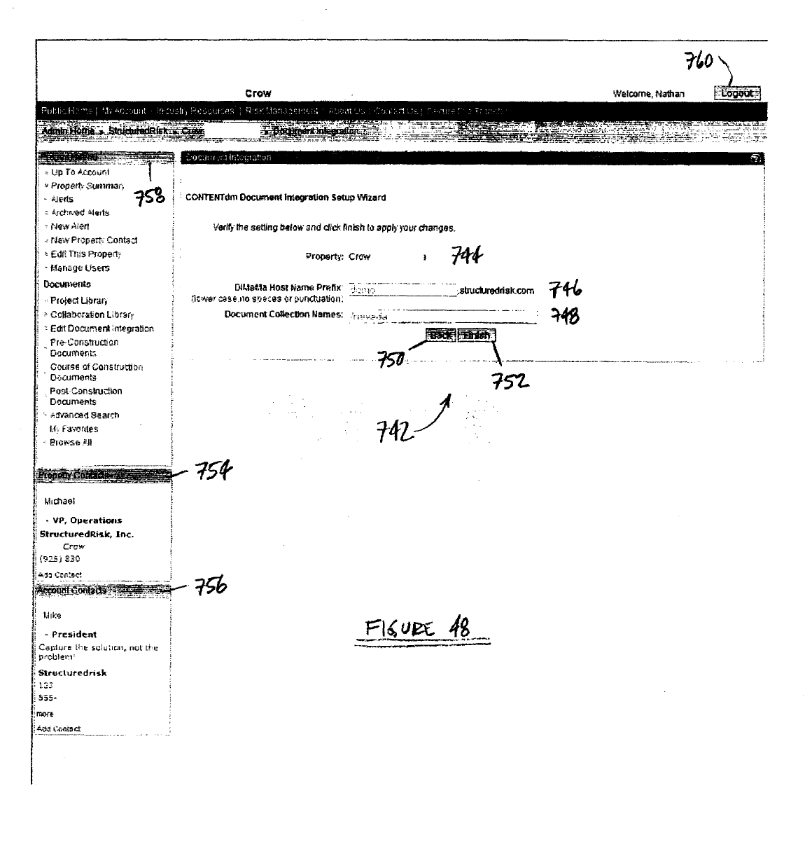

FIG. 48 is another example embodiment of a user interface 742 displaying a Document Integration page. The Document Integration page includes a Property field 744, a Host Name Prefix Section 746, a Document Collection Name Field 748, a Back button 750, a Finish button 752, a Property Contacts Section 754, an Account Contacts Section 756, a Property Menu 758 that includes links to other RMS system pages and a logout button 760.

In the example embodiment, the Administrator navigates to Document Integration page 742 by clicking on Continue button 732 of Document Integration page 722. The Administrator clicks on Finish button 752 to apply the changes to the Host Name Prefix Section 746 and the Document Collection Names Field 748. By Clicking on the Back button 750, the Administrator navigates back to the Document Integration page 722. The Administrator may also select any of the page links contained in the Property Menu 758 section to proceed directly to another page. Should the Administrator desire to exit the system while on the Document Integration page 742, he clicks the logout button 760.

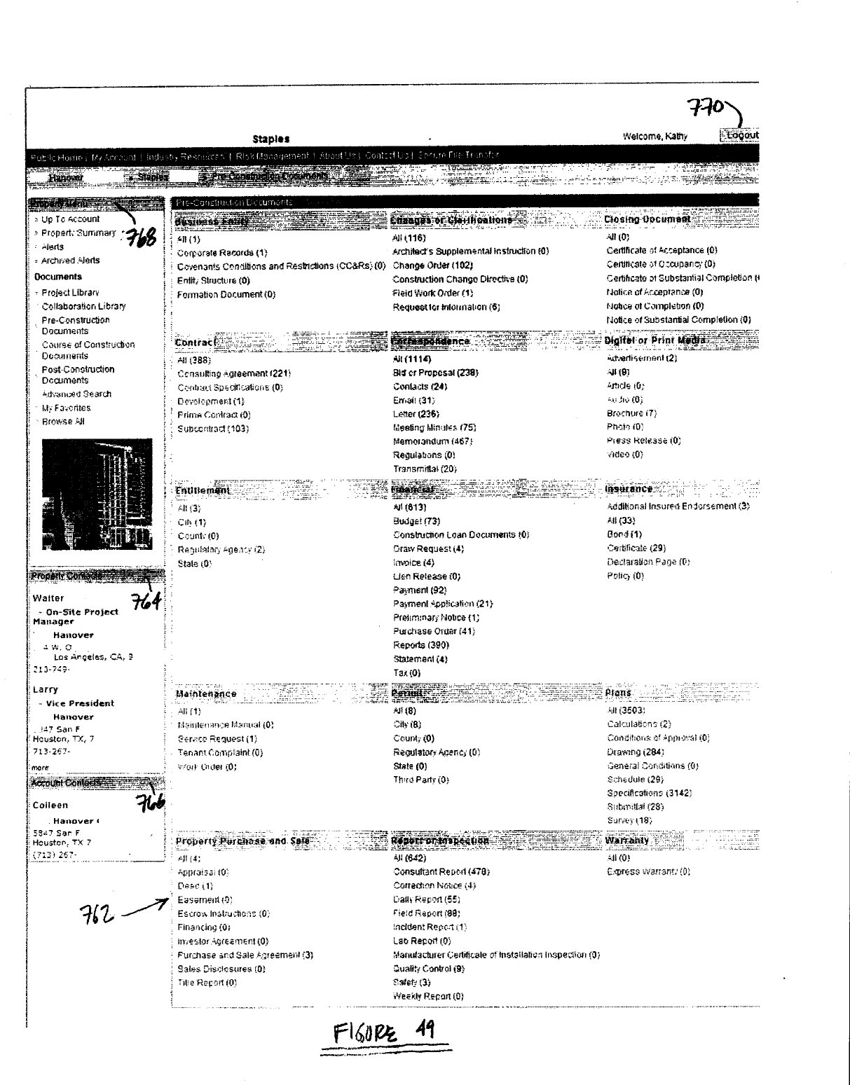

FIG. 49 is an example embodiment of a user interface 762 displaying a Pre-Construction Documents page for accessing documents generated during the Pre-Construction phase of construction. It includes a Business Entity Section, a Changes or Clarifications Section, a Closing Document Section, a Contract Section, a Correspondence Section, a Digital or Print Media Section, an Entitlement Section, a Financial Section, an Insurance Section, a Maintenance Section, a Permit Section, a Plans Section, a Property Purchase and Sale Section, a Report or Inspection Section, and a Warranty Section. Each of these sections contains a list of several types of documents generated during this phase of construction. Each item in the list is also an electronic link. There is a number next to each document link indicating the number of those documents in the RMS system. If the number is zero, there are no documents of that type in the RMS system. The Pre-Construction Documents page also includes a Property Contacts Section 764, an Account Contacts Section 766, Property Menu 768 that includes links to other RMS system pages and a logout button 770.

In the example embodiment, the Administrator views the various types of documents and clicks on a particular document type link to view those types of documents. The Administrator may also select any of the page links contained in the Property Menu 768 section to proceed directly to another page. Should the Administrator desire to exit the system while on the Pre-Construction Documents page, he clicks the logout button 770.

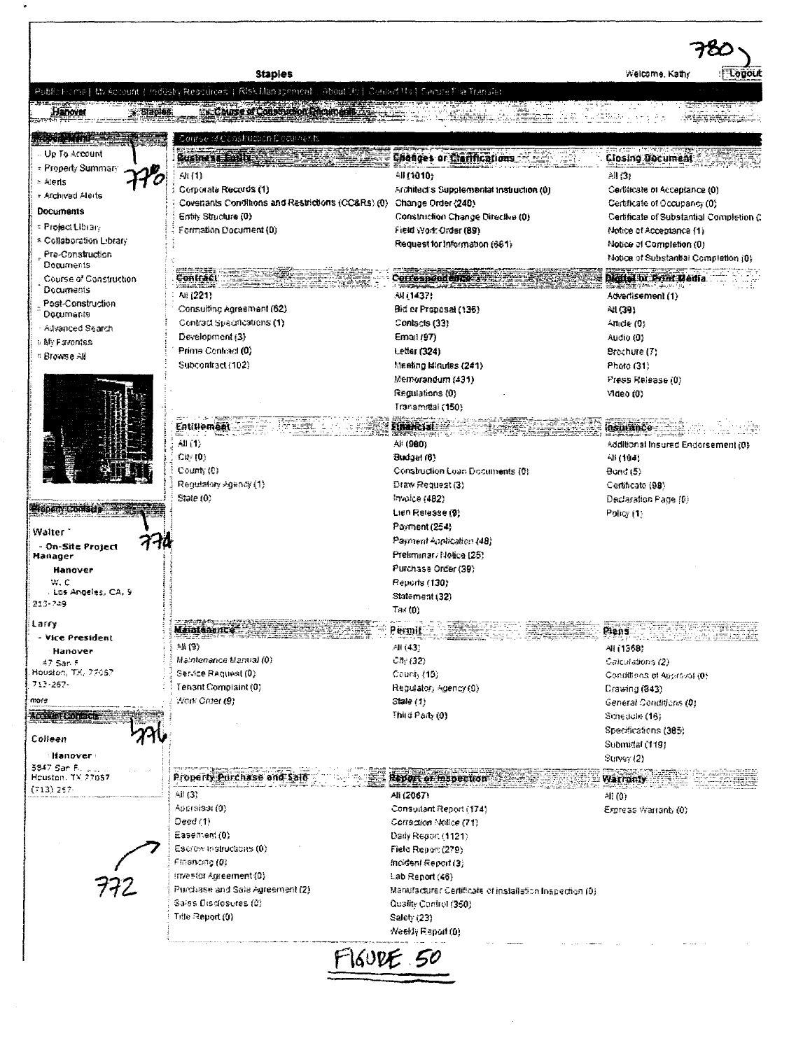

FIG. 50 is an example embodiment of a user interface 772 displaying a Course-of-Construction Documents page for accessing documents generated during the Course-of-Construction. It includes a Business Entity Section, a Changes or Clarifications Section, a Closing Document Section, a Contract Section, a Correspondence Section, a Digital or Print Media Section, an Entitlement Section, a Financial Section, an Insurance Section, a Maintenance Section, a Permit Section, a Plans Section, a Property Purchase and Sale Section, a Report or Inspection Section, and a Warranty Section. Each of these sections contains a list of several types of documents generated during the Course-of-Construction. Each item in the list is also an electronic link. There is a number next to each document link indicating the number of those documents in the RMS system. If the number is zero, there are no documents of that type in the RMS system. This page also has a Property Contacts Section 774, an Accounts Contacts Section 776, a Property Menu 778 that includes links to other RMS system pages and a logout button 780.

In the example embodiment, the Administrator views the various types of documents and clicks on a particular document type link to view those types of documents. The Administrator may also select any of the page links contained in the Property Menu 778 section to proceed directly to another page. Should the Administrator desire to exit the system while on the Course-of-Construction Documents page, he clicks the logout button 780.

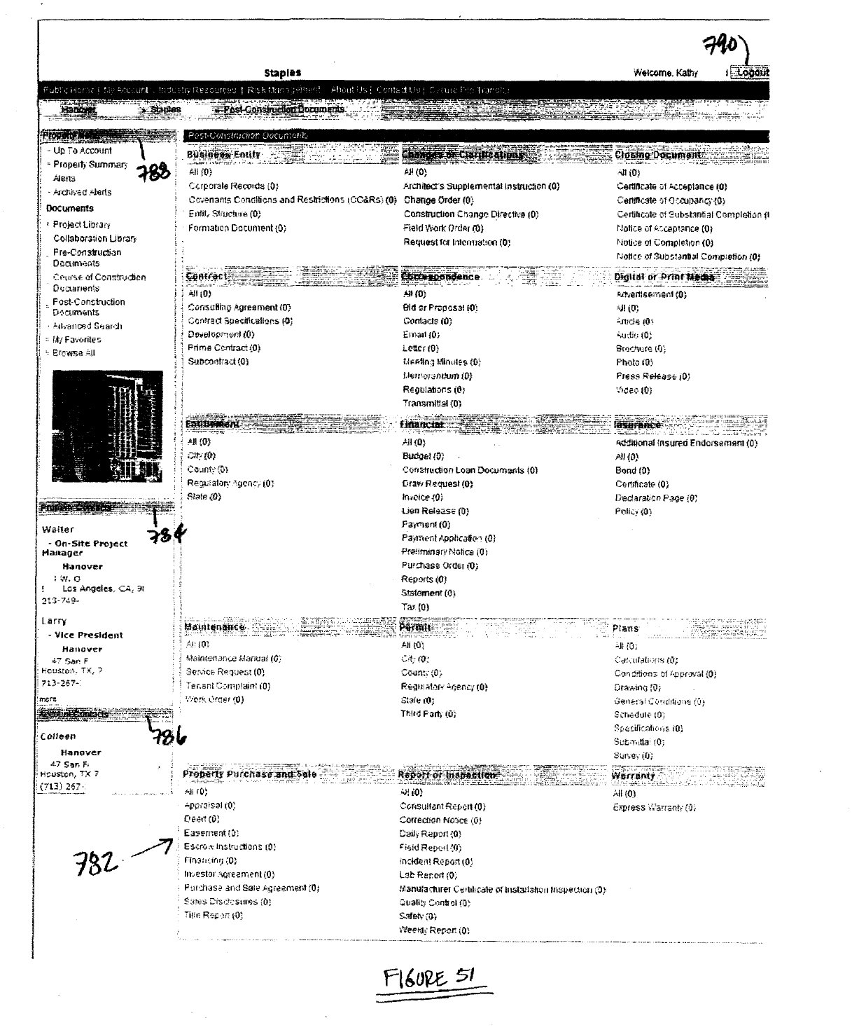

FIG. 51 is an example embodiment of a user interface 782 displaying a Post-Construction Documents page for accessing documents generated after construction has ended. It includes a Business Entity Section, a Changes or Clarifications Section, a Closing Document Section, a Contract Section, a Correspondence Section, a Digital or Print Media Section, an Entitlement Section, a Financial Section, an Insurance Section, a Maintenance Section, a Permit Section, a Plans Section, a Property Purchase and Sale Section, a Report or Inspection Section, and a Warranty Section. Each of these sections contains a list of several types of documents generated after construction has ended. Each item in the list is also an electronic link. There is a number next to each document link indicating the number of those documents in the RMS system. If the number is zero, there are no documents of that type in the RMS system. This page also has a Property Contacts Section 784, an Account Contacts Section 786, Property Menu 788 that includes links to other RMS system pages and a logout button 790.

In the example embodiment, the Administrator views the various types of documents and clicks on a particular document type link to view those types of documents. The Administrator may also select any of the page links contained in the Property Menu 788 section to proceed directly to another page. Should the Administrator desire to exit the system while on the Post-Construction Documents page, he clicks the logout button 790.

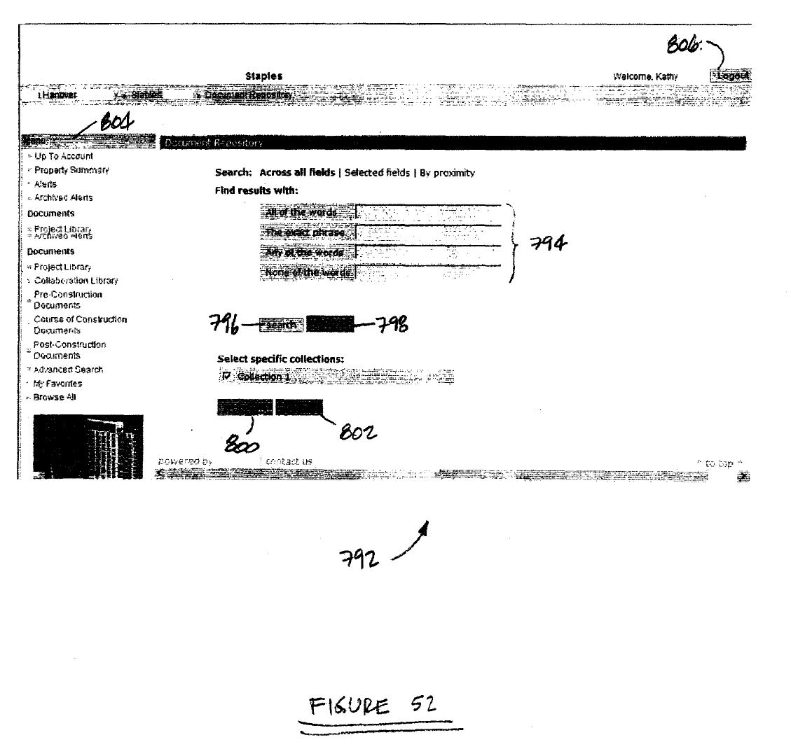

FIG. 52 is an example embodiment of a user interface 792 displaying a Document Repository—Advanced Search page for searching the documents in the system database or repository. It includes a Search Section containing several data fields 794, a search button 796 and a clear all button 798. The Search Section also includes different types of searches: Across all fields; Selected fields; and, by proximity. The data fields 794 define the search, such as All of the Words, The Exact Phrase, Any of the Words, and None of the Words. The Document Repository Page also includes Select Specific Collections section that has a check box for a Collection 1 and a select all button 800 and a clear all button 802. This page also has Menu 804 that includes links to other RMS system pages and a logout button 806.

In the example embodiment, the Administrator selects the type of search, enters the wording to search in a data field 794 and clicks on the Search button 796. Further, the Administrator can select a specific collection. The search should find all documents fitting the search criteria. The Administrator may also select any of the page links contained in the Menu 804 section to proceed directly to another page. Should the Administrator desire to exit the system while on the Document Repository page, he clicks the logout button 806.

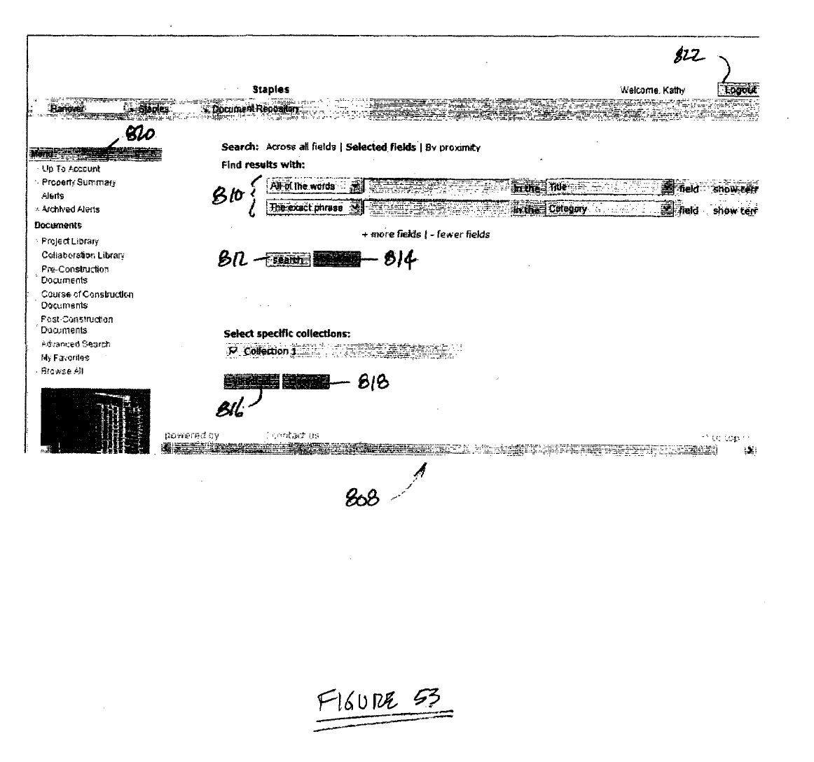

FIG. 53 is another example embodiment of a user interface 808 displaying yet another Document Repository page for searching the documents in the system database or repository. It includes a Search Section containing several data fields 810, a search button 812 and a clear all button 814. The Search Section also includes different types of searches: Across all fields; Selected fields; and, by proximity. The data fields 810 define the search, such as All of the Words and The Exact Phrase. There are also different fields to search, such as the Title and Category. The Document Repository page also includes a Select Specific Collections section that has a check box for a Collection 1, a select all button 816 and a clear all button 818. This page also has Menu 820 that includes links to other RMS system pages and a logout button 822.

In the example embodiment, the Administrator selects the type of search, enters the wording to search in a data field, selects the fields to be searched and clicks on the Search button 812. Further, the Administrator can select a specific collection. The search should find all documents fitting the search criteria. The Administrator may also select any of the page links contained in the Menu 820 section to proceed directly to another page. Should the Administrator desire to exit the system while on the Document Repository page, he clicks the logout button 822.

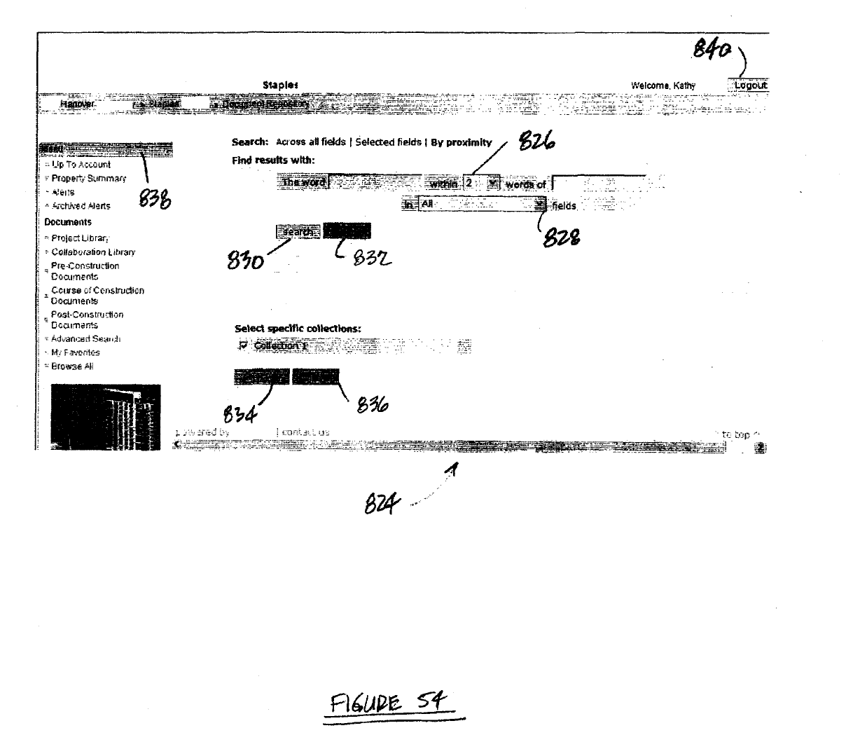

FIG. 54 is another example embodiment of a user interface 824 displaying another Document Repository—Advanced Search page for searching the documents in the system database or repository. It includes a Search Section containing data fields, a Within pull-down menu 826, a fields pull-down menu 828, a search button 830 and a clear all button 832. The data fields define the search, being The Word Within ‘n’ number of Words Of wherein ‘n’ indicates a numerical value. This Document Repository page also includes a Select Specific Collections section that includes a check box for a Collection 1, a select all button 834 and a clear all button 836. This page also has Menu 838 including links to other RMS system pages and a logout button 840.

In the example embodiment, the Administrator selects the type of search, enters the word to search for, uses the pull down 826 to choose the proximity, enters words in the “Words of” field, toggles the fields pull-down menu 828 and clicks on the Search button 830. Further, the Administrator can select a specific collection. The search should find all documents fitting the search criteria. The Administrator may also select any of the page links contained in the Menu 838 section to proceed directly to another page. Should the Administrator desire to exit the system while on the Document Repository page, he clicks the logout button 840.

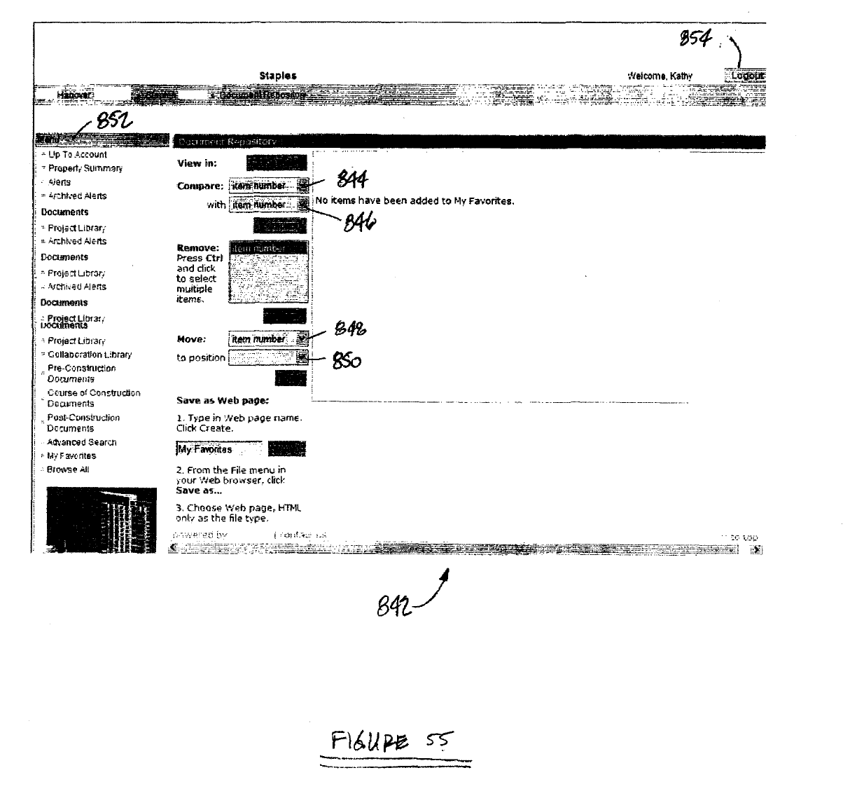

FIG. 55 is an example embodiment of a user interface 842 displaying another Document Repository—My Favorites Page. It includes several data fields including: View in, Compare, Remove, Move and Position. The compare data field comprises two item toggles 844 and 846. The Move data field comprises two similar item toggles 848 and 850. This page also includes a compare button, a remove button, a move button, a Save as Web page section and a Menu 852 that includes links to other RMS system pages and a logout button 854.

In the example embodiment, an Administrator selects a document using item toggle 844 and selects another document using item toggle 846. When the Administrator presses the compare button, the differences between the two documents is shown using red lines. The Administrator may also select a document item number from the Remove section and press the Remove button to remove the selected document. The Administrator may also select a document using toggle 848 and move it to a position selected using toggle 850. The Administrator presses the move button to implement the move. The Save as Web page portion allows an Administrator to send e-mails.

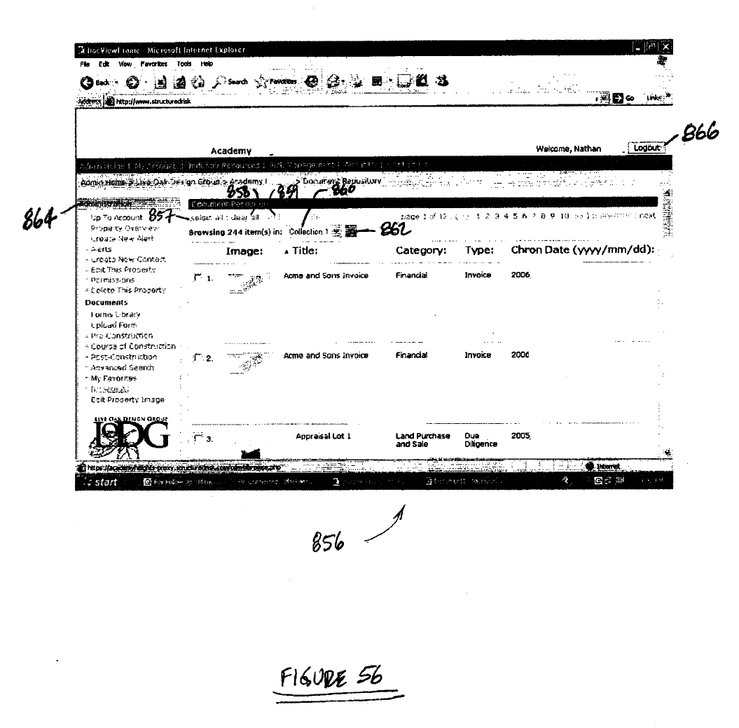

FIG. 56 is another example embodiment of a user interface 856 displaying a Document Repository—Browse All page. It includes a select all field 857, a clear all field 858, an add to favorites field 859, and a page field. There is a Browsing pull-down toggle 860 and a Go button 862. Additionally, the Document Repository page has documents listed with a corresponding project image, Document Title, Document Category and Document Type. The documents are listed chronologically by date. This page also has Administration Section 864 that includes links to other RMS system pages and a logout button 866.

In the example embodiment, the Administrator selects the collection of documents to browse through by toggling the Browsing Pull-Down Toggle 860 and clicking on the Go button 862. By clicking on the Document Image, the Administrator may view a document. The Administrator may also select any of the page links contained in the Administration Section 864 to proceed directly to another page. Should the Administrator desire to exit the system while on the Document Repository page, he clicks the logout button 866.

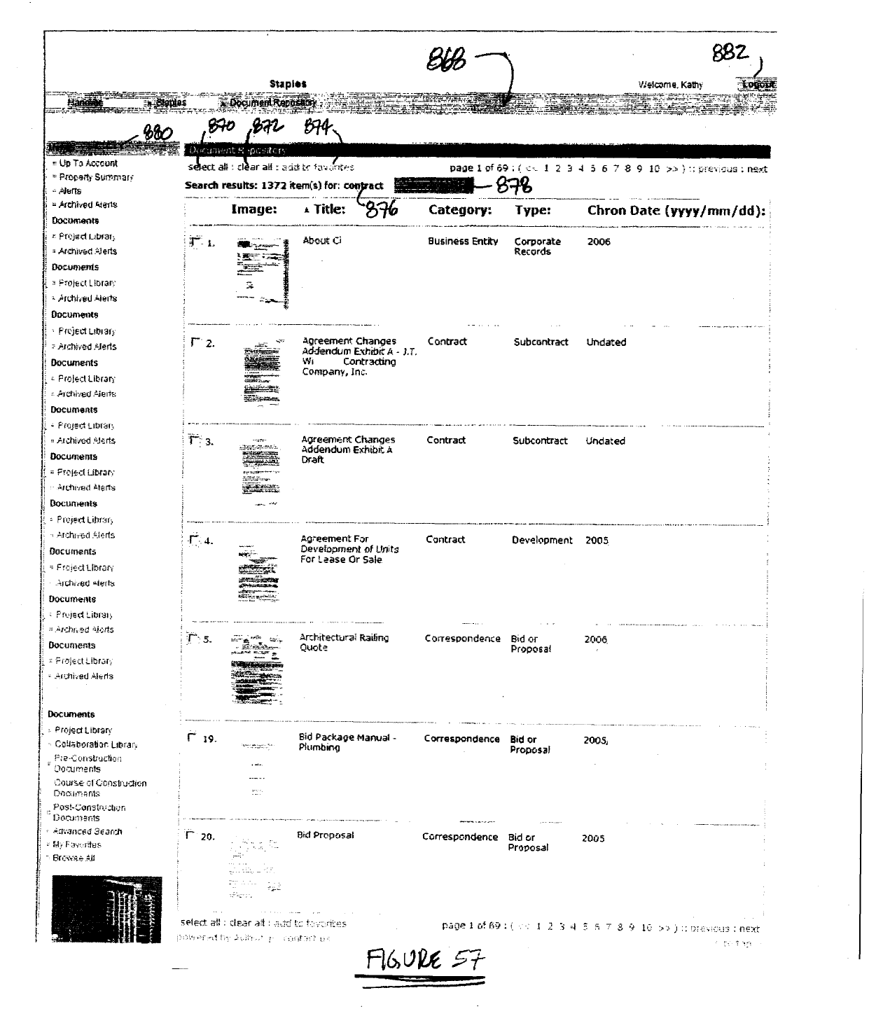

FIG. 57 is another example embodiment of a user interface 868 displaying another Document Repository—Search Results page. It includes a select all field 870, a clear all field 872, an add to favorites field 874, and a page field. There is a Search Text Field 876 and a Search Again button 878. Additionally, the Document Repository page has documents listed with a corresponding project image, Document Title, Document Category and Document Type. The documents are listed chronologically by date. This page also has Menu 880 that includes links to other RMS system pages and a logout button 882.

In the example embodiment, the Administrator selects which documents to browse through by entering search terms in Search Text Field 876, then clicking on the Search Again button 878. By clicking on the Document Image, the Administrator may view a document. The Administrator may also select any of the page links contained in the Menu 880 section to proceed directly to another page. Should the Administrator desire to exit the system while on the Document Repository page, he clicks the logout button 882.

While the invention has been described with reference to a specific embodiment, the description of the specific embodiment is illustrative only and is not to be construed as limiting the scope of the invention. Various other modifications and changes may occur to those skilled in the art without departing from the spirit and scope of the invention.

What is claimed is:

1. A method for managing risk associated with a construction project by a business entity using a computer system coupled to a database, said method comprising:
storing within the database information relating to at least one construction project including tasks to be performed and deadlines associated with each task, the information stored within the database further including a plurality of documents associated with the at least one construction project;
analyzing a content of each document stored within the database;
determining whether to trigger an alert based on the content of each document, wherein an alert represents a failure to perform at least one of the tasks of the construction project before the scheduled deadline;
displaying on the computer system each alert relating to the construction project;
prompting a user to associate with the business entity to take steps to correct each alert displayed on the computer system to facilitate timely completion of the construction project; and
updating the alerts displayed on the computer system to include the corrective steps taken by the user.

2. A method in accordance with claim 1 further comprising the steps of:
assigning a code to each document stored within the database based on the content of the corresponding document;
mapping a location of each document stored within the database based on the code assigned to the corresponding document;
displaying on the computer system an organizational structure for organizing the documents stored within the database based on the code assigned to each document and the location mapping.

3. A method in accordance with claim 2 wherein displaying an organizational structure further comprises defining the organizational structure to include a pre-construction document directory, a course-of-construction document directory and a post-construction document directory, and defining each document directory to include a plurality of folders and labeling the folders to reflect the content of a corresponding document.

4. A method in accordance with claim 3 wherein defining each document directory to include a plurality of folders further comprises generating the plurality of folders to comprise at least a business entity folder, a changes or clarifications folder, a closing documents folder, a contracts folder, a correspondence folder, a digital or print media folder, an entitlements folder, a financials folder, an insurance folder, a maintenance folder, a permits folder, a plans folder, a property purchase and sale folder, a report or inspection folder and a warranty folder.

5. A method in accordance with claim 4 further comprising customizing the plurality of folders by defining additional folders to correspond with additional construction activities.

6. A method in accordance with claim 3 further comprising receiving a notice to proceed to define an event that distinguishes between identifying a document as a pre-construction document and a course-of-construction document and receiving a notice of completion to define an event that identifies a document as a course of construction document and a post-construction document.

7. A method in accordance with claim 6 further comprising identifying a document received prior to receiving the notice to proceed as a pre-construction document and identifying a document received after receiving the notice to proceed as a course-of-construction document.

8. A method in accordance with claim 6 further comprising identifying a document received prior to receiving the notice of completion as a course-of-construction document and identifying a document received after the notice of completion as a post-construction document.

9. A method in accordance with claim 1 further comprising defining each document to comprise at least one page and assigning the at least one page a predetermined document identification number and increasing the document identification number sequentially to a total number of documents so each document receives a unique document identification number.

10. A method in accordance with claim 1 further comprising assigning to the alert an alert status selected from a hierarchy of alerts comprising a red alert, a yellow alert, a green alert and a black alert.

11. A method in accordance with claim 10 further comprising defining the red alert status to indicate an attempt has not been made to resolve an event, defining the yellow alert status to indicate an event is in progress towards resolution, defining the green alert status to indicate an event is resolved and defining the black alert status to indicate the alert has not been given at least one of red, yellow, and green status.

12. A method in accordance with claim 1 further comprising establishing an electronic link between the alert and the corresponding document that triggered the alert.

13. A computer system for a company engaged in the business of managing risk, said computer system comprising:
at least one computer configured as a server, said server associated with said risk management company and containing a database, said server configured to:
store within said database information relating to at least one construction project including tasks to be performed and deadlines associated with each task, said information stored within said database further including a plurality of documents associated with said at least one construction project;
analyze a content of each document stored within said database;
determine whether to trigger an alert based on the content of each document, wherein an alert represents a failure to perform at least one of said tasks of said construction project before said scheduled deadline;
display on said computer system each alert relating to said construction project;
prompt a user to associate with said business entity to take steps to correct each alert displayed on said computer system to facilitate timely completion of said construction project; and
update said alerts displayed on said computer system to include said corrective steps taken by said user.

14. A computer system in accordance with claim 13 wherein said server is further configured to:
assign a code to each document stored within said database based on said content of said corresponding document;
map a location of each document stored within said database based on said code assigned to said corresponding document;
display on said computer system an organizational structure for organizing said documents stored within said database based on said code assigned to each document and said mapped location.

15. A computer system in accordance with claim 14 wherein said server is further configured to define said organizational structure to include a pre-construction document directory, a course-of-construction document directory and a post-construction document directory, and defining each document directory to include a plurality of folders and labeling said folders to reflect the content of a corresponding document.

16. A computer system in accordance with claim 15 wherein said server is further configured to generate said plurality of folders to comprise at least a business entity folder, a changes or clarifications folder, a closing documents folder, a contracts folder, a correspondence folder, a digital or print media folder, an entitlements folder, a financials folder, an insurance folder, a maintenance folder, a permits folder, a plans folder, a property purchase and sale folder, a report or inspection folder and a warranty folder.

17. A computer system in accordance with claim 16 wherein said server is further configured to customize said plurality of folders by defining additional folders to correspond with additional construction activities.

18. A computer system in accordance with claim 15 wherein said server is further configured to define a first event based on a notice to proceed that distinguishes between identifying a document as a pre-construction document and a course-of-construction document and define a second event based on a notice of completion that distinguishes between identifying a document as a course of construction document and a post-construction document.

19. A computer system in accordance with claim 18 wherein said server is further configured to identify a document received prior to receiving said notice to proceed as a pre-construction document and identifying a document received after receiving said notice to proceed as a course-of-construction document.

20. A computer system in accordance with claim 18 wherein said system is configured to identify a document received prior to receiving said notice of completion as a course-of-construction document and identify a document received after said notice of completion as a post-construction document.

21. An apparatus comprising:
means associated with a risk management company for storing information relating to at least one construction project including tasks to be performed and deadlines associated with each task, said information including a plurality of documents associated with said at least one construction project;
means for analyzing a content of each document;
means for determining whether to trigger an alert based on the content of each document, wherein an alert represents a failure to perform at least one of said tasks of said construction project before said scheduled deadline;
means for displaying each alert relating to said construction project;
means for prompting a user to associate with said business entity to take steps to correct each displayed to facilitate timely completion of said construction project; and
means for updating said displayed alerts to include said corrective steps taken by said user.

22. An apparatus in accordance with claim 21 further comprising:
means for assigning a code to each document based on said content of said corresponding document;
means for mapping a location of each document based on said code assigned to said corresponding document;
means for displaying an organizational structure for organizing said documents based on said code assigned to each document and said mapped location.

23. An apparatus in accordance with claim 22 further comprising means for defining said organizational structure to include a pre-construction document directory, a course-of-construction document directory and a post-construction document directory, and for defining each document directory to include a plurality of folders and labeling said folders to reflect the content of a corresponding document.

24. An apparatus in accordance with claim 23 further comprising means for generating said plurality of folders to comprise at least a business entity folder, a changes or clarifications folder, a closing documents folder, a contracts folder, a correspondence folder, a digital or print media folder, an entitlements folder, a financials folder, an insurance folder, a maintenance folder, a permits folder, a plans folder, a property purchase and sale folder, a report or inspection folder and a warranty folder.

25. An apparatus in accordance with claim 24 further comprising means for customizing said plurality of folders by defining additional folders to correspond with additional construction activities.

26. An apparatus in accordance with claim 23 further comprising means for defining a first event based on a notice to proceed that distinguishes between identifying a document as a pre-construction document and a course-of-construction document and for defining a second event based on a notice of completion that distinguishes between identifying a document as a course of construction document and a post-construction document.

27. An apparatus in accordance with claim 26 further comprising means for identifying a document received prior to receiving said notice to proceed as a pre-construction document and means for identifying a document received after receiving said notice to proceed as a course-of-construction document.

28. An apparatus in accordance with claim 26 further comprising means for identifying a document received prior to receiving said notice of completion as a course-of-construction document and means for identifying a document received after said notice of completion as a post-construction document.
